(19) United States
(12) Patent Application Publication
(10) Pub. No.: US 2025/0062378 A1
(43) Pub. Date: Feb. 20, 2025

(54) SOLID OXIDE CELLS WITH POROUS LAYERS, AND METHODS FOR FABRICATION THEREOF

(71) Applicant: UNIVERSITY OF MARYLAND, COLLEGE PARK, College Park, MD (US)

(72) Inventors: Eric WACHSMAN, Fulton, MD (US); Ian ROBINSON, Silver Spring, MD (US); Sam HORLICK, Columbus, OH (US); Yi-Lin HUANG, Potomac, MD (US)

(21) Appl. No.: 18/721,055

(22) PCT Filed: Dec. 22, 2022
(86) PCT No.: PCT/US22/53810

§ 371 Date: Jun. 17, 2024

Related U.S. Application Data
(60) Provisional application No. 63/265,921, filed on Dec. 22, 2021.
(60) Provisional application No. 63/265,920, filed on Dec. 22, 2021.

(51) Int. Cl. H01M 8/1246; H01M 4/86; H01M 4/88; H01M 8/0206; H01M 8/12

(52) U.S. Cl. CPC H01M 8/1246; H01M 4/8605; H01M 4/8652; H01M 4/8885; H01M 8/0206; H01M 2008/1293

(57) ABSTRACT

A solid oxide cell can comprise a nonporous oxide layer, one or more first porous layers, and one or more second porous layers. The nonporous oxide layer can conduct oxygen ions and can operate as a solid electrolyte. The first and second porous layers can be disposed on opposite sides of the nonporous oxide layer. The nonporous oxide layer can have a density greater than that of each of the first and second porous layers. In some embodiments, at least one of the one or more first porous layers can be infiltrated with one or more electrocatalytic oxides. Alternatively, in some embodiments, a porous functional layer can be disposed between the nonporous oxide layer and the one or more first porous layers. The porous functional layer can be effective to increase an open circuit voltage of the solid oxide cell.

### CROSS-REFERENCE TO RELATED APPLICATIONS

The present application claims the benefit of U.S. Provisional Application No. 63/265,920, filed Dec. 22, 2021, entitled “Scaffold Infiltrated Cathodes for Low-Temperature Solid Oxide Fuel Cells,” and U.S. Provisional Application No. 63/265,921, filed Dec. 22, 2021, entitled “Porous Ceria-Based Functional Layer for Solid Oxide Cells,” each of which is hereby incorporated by reference herein in its entirety.

### STATEMENT REGARDING FEDERALLY SPONSORED RESEARCH

This invention was made with government support under DEFE0031662 awarded by the United States Department of Energy, Office of Fossil Energy, and DEAR0001345 awarded by the United States Department of Energy, Advanced Research Projects Agency-Energy (DOE ARPA-E). The government has certain rights in the invention.

### FIELD

The present disclosure relates generally to solid oxide electrochemical cells, and more particularly, to solid oxide electrochemical cells with porous layers to enhance low-temperature performance thereof.

### BACKGROUND

Solid oxide electrochemical cells (SOCs) are on the forefront of clean energy research to mitigate the effects of climate change. SOCs can operate either in a fuel cell mode (e.g., solid oxide fuel cell or SOFC) to generate electricity from a chemical fuel or in an electrolysis mode (e.g., solid oxide electrolysis cell or SOEC) to use electricity to generate chemical fuels and store for future use. In conventional SOCs, high temperatures (e.g., >800° C.) are needed to thermally activate oxygen ion transport and electrode reaction processes. Such high temperatures, however, also introduce degradation issues. Accordingly, lowering the operating temperatures of SOCs could help advance adoption and commercialization. One of the challenges to lowering the operating temperature is that ohmic loss of the electrolyte increases with decreasing temperature, thereby reducing SOC performance. In addition, the sluggish kinetics of the oxygen reduction reaction (ORR) at cathode can limit performance at low temperatures (e.g., <650° C.).

Among existing solid oxide electrolytes, doped ceria (such as Ce₁₋ₓGdₓO_{2-δ} (GDC) and Ce₁₋ₓSmₓO_{2-δ} (SDC) may be an attractive option for low temperature applications due to their higher oxygen ion conductivity. However, ceria-based electrolytes are mixed ionic and electronic conductors (MIEC), since cerium undergoes Ce⁴⁺/Ce³⁺ redox couple under reducing conditions. This can cause the open circuit voltage (OCV) of SOCs to be lower than theoretical, decreasing the efficiency of the device. In addition, for SOECs where electricity is converted into chemicals, the electronic conduction in the electrolyte can lower the oxygen ion transference number, thereby making ceria-based electrolytes impractical to function in electrolysis mode because of lower Faradaic efficiency.

Embodiments of the disclosed subject matter may address one or more of the above-noted problems and disadvantages, among other things.

### SUMMARY

Embodiments of the disclosed subject matter provide enhanced performance solid oxide cells by appropriate construction of one or more porous layers on an oxygen-side of a nonporous oxide layer (also referred to herein as a dense electrolyte layer, or DEL). In some embodiments, the one or more porous layers can serve as an electrode (e.g., cathode in SOFC mode), for example, by infiltration with one or more electrocatalysts. In some embodiments, the sintering of the one or more porous layers and subsequent electrocatalytic infiltration is performed at a temperature below a first threshold (e.g., 1000° C.) to achieve a minimum, or at least reduced, area specific resistance (ASR). Alternatively or additionally, in some embodiments, the electrocatalytic infiltration and/or subsequent operation of the SOC is performed at a temperature below a second threshold (e.g., 650° C.) to maintain a nanoscale size (e.g., average particle size ≤200 nm) of the electrocatalysts, thereby allowing fast oxygen transport while providing an electronically connective network that facilitates electrochemical reactions.

In some embodiments, the one or more porous layers is a porous functional layer (PFL) disposed between the nonporous oxide layer and an air-side electrode. In some embodiments, the PFL can increase exposure of the nonporous oxide layer to a higher oxygen partial pressure (pO₂), thereby limiting the electronic conductivity of the nonporous oxide layer and mitigating any leakage current therein. The provision of the PFL can also increase the effective ionic transference number, t_{O}_{^{2−}}, to further improve the efficiency of the nonporous oxide layer and/or allow a thinner nonporous oxide layer to be employed. In some embodiments, an SOC with a PFL can exhibit a higher open circuit voltage (e.g., at least 0.90 V at a temperature in a range of 500-550° C.) and/or lower ASR.

In one or more embodiments, a solid oxide cell can comprise a nonporous oxide layer, one or more first porous layers, and one or more second porous layers. The nonporous oxide layer can be constructed to conduct oxygen ions and to operate as a solid electrolyte. The one or more first porous layers can be disposed over a first side of the nonporous oxide layer. The one or more second porous layers can be disposed over a second side of the nonporous oxide layer opposite the first side. The nonporous oxide layer can have a density greater than that of each of the first and second porous layers. An electronic conductivity of the nonporous oxide layer can be less than 25% of an ionic conductivity of the nonporous oxide layer. For each of the first and second porous layers, an electronic conductivity of the respective porous layer can be greater than 25% of an ionic conductivity of the respective porous layer. At least one of the one or more first porous layers can be constructed to operate as a first electrode, and at least one of the one or more second porous layers can be constructed to operate as a second electrode.

In one or more embodiments, a solid oxide cell can comprise a nonporous oxide layer, a porous functional layer, one or more first porous layers, and one or more second porous layers. The nonporous oxide layer can be constructed to conduct oxygen ions and to operate as a solid electrolyte. The porous functional layer can be disposed over a first side of the nonporous oxide layer. The one or more first porous layers can be disposed over a side of the porous functional layer opposite the nonporous oxide layer. The one or more second porous layers can be disposed over a second side of the nonporous oxide layer the opposite the first side. The nonporous oxide layer can have a density greater than that of the porous functional layer. An electronic conductivity of the nonporous oxide layer can be less than 25% of an ionic conductivity of the nonporous oxide layer. The porous functional layer can be effective to increase the ionic transference number of the nonporous oxide layer and the porous functional layer to at least 0.9 at a temperature less than or equal to 550° C. At least one of the one or more first porous layers can be constructed to operate as a first electrode, and at least one of the one or more second porous layers can be constructed to operate as a second electrode.

In one or more embodiments, a method of fabricating a solid oxide cell can comprise providing one or more first precursors for forming one or more second porous layers. The method can further comprise providing one or more second precursors for forming a nonporous oxide layer on the one or more first precursors. The method can also comprise sintering the first and second precursors at a temperature greater than or equal to a first threshold, so as to form the one or more second porous layers over a second side of the nonporous oxide layer. The method can further comprise providing one or more third precursors for forming one or more first porous layers over a first side of the nonporous oxide layer opposite the second side. The method can also comprise sintering the one or more third precursors at a temperature less than the first threshold, so as to form the one or more first porous layers over the first side of the nonporous oxide layer. The nonporous oxide layer can have a density greater than that of the first and second porous layers. For each of the first and second porous layers, an electronic conductivity of the respective porous layer can be greater than 25% of the ionic conductivity of the respective porous layer. At least one of the one or more first porous layers can be constructed to operate as a first electrode, and at least one of the one or more second porous layers can be constructed to operate as a second electrode.

In one or more embodiments, a method of fabricating a solid oxide cell can comprise providing one or more first precursors for forming one or more second porous layers. The method can further comprise providing one or more second precursors for forming a nonporous oxide layer on the one or more first precursors. The method can also comprise sintering the first and second precursors at a temperature greater than or equal to a first threshold, so as to form the one or more second porous layers over a second side of the nonporous oxide layer. The method can further comprise providing one or more third precursors for forming a porous functional layer over a first side of the nonporous oxide layer opposite the second side. The method can also comprise providing one or more fourth precursors for forming one or more first porous layers over the one or more third precursors. The method can further comprise sintering the third and fourth precursors at a temperature less than the first threshold, so as to form the porous functional layer over the first side of the nonporous oxide layer and to form the one or more first porous layer over a side of the porous functional layer opposite the nonporous oxide layer. The nonporous oxide layer can have a density greater than that of the first and second porous layers. For each of the first and second porous layers, an electronic conductivity of the respective porous layer can be greater than 25% of the ionic conductivity of the respective porous layer. The porous functional layer can be effective to increase an ionic transference number of the nonporous oxide layer and the porous functional layer to at least 0.9 at a temperature less than or equal to 550° C. At least one of the one or more first porous layers can be constructed to operate as a first electrode, and at least one of the one or more second porous layers can be constructed to operate as a second electrode.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1A is a schematic illustrating a simplified cross-section of a layer assembly for a solid oxide electrochemical cell (SOC) with an electrode formed by infiltration of a porous layer, according to one or more embodiments of the disclosed subject matter.

FIG. 1B illustrates an exemplary configuration of an SOC with an infiltrated porous layer, according to one or more embodiments of the disclosed subject matter.

FIG. 1C illustrates a potential oxygen transport mechanism for an oxygen containing gas composite electrode in a conventional SOC.

FIG. 1D illustrates a potential oxygen transport mechanism for an electrode formed by an infiltrated porous layer, according to one or more embodiments of the disclosed subject matter.

FIG. 2A is a schematic illustrating a simplified cross-section of a layer assembly for a solid oxide electrochemical cell (SOC) with a porous functional layer, according to one or more embodiments of the disclosed subject matter.

FIG. 2B illustrates an exemplary configuration of an SOC with a porous functional layer, according to one or more embodiments of the disclosed subject matter, as well as a scanning electron microscope (SEM) image of a fabricated porous functional layer microstructure.

FIG. 2C shows theoretical electron charge carrier density versus cross-sectional location for SOCs with and without a porous functional layer. FIG. 2D shows the theoretical ratio of ionic conductivity to total conductivity (t_{O}_{^{2−}}) versus cross-sectional location for SOCs with and without a porous functional layer.

FIGS. 3A-3B are simplified schematic diagrams of an SOC with porous layer(s) operating in fuel cell mode and in an electrolyzer mode, respectively, according to one or more embodiments of the disclosed subject matter.

FIG. 3C depicts a generalized example of a computing environment in which the disclosed technologies may be implemented.

FIG. 4 is a process flow diagram illustrating a simplified method for fabricating an SOC with porous layer(s), according to one or more embodiments of the disclosed subject matter.

FIG. 5A is a Nyquist plot at open circuit voltage (OCV) at 550° C. of a fabricated symmetrical cell with Pr-Sr-Co (PSC) infiltrated porous layer for different temperatures for sintering of the porous layer.

FIG. 5B is a graph of area specific resistance (ASR) of cathodes formed by infiltrated porous layers at different operating temperatures, as a function of temperature for sintering of the porous layer (X-axis).

FIG. 5C shows distribution of relaxation times (DRT) analysis for a conventional composite cathode (SSC-GDC) and an infiltrated porous layer cathode (PSC-inf GDC) at OCV at 550° C.

FIGS. 6A-6B show current-voltage characteristics and electrochemical impedance spectroscopy (EIS) spectra, respectively, for various compositions of the porous layer and electrocatalyst loadings for an SOC with infiltrated porous layer cathode in air and anode in 97% H₂/3% H₂O at 550° C.

FIG. 6C is a graph of ohmic resistance versus lanthanide loading for an SOC with a porous layer cathode.

FIG. 6D is a graph of ASR and peak power density (PPD) for an SOC with a porous 5 wt % Pr-GDC layer cathode infiltrated based on PSC loading.

FIGS. 7A-7B show current-voltage characteristics and EIS spectra, respectively, for SOCs with a cathode formed by a PSC-infiltrated Pr-Sm-GDC porous layer, an Ni-GDC anode, and different GDC electrolyte thicknesses in H₂ at 500° C. and 550° C. FIGS. 7C-7D are scanning electron microscopy (SEM) images of a full cross-section and the cathode, respectively, of an SOC with PSC-infiltrated Pr-Sm-GDC porous layer, an Ni-GDC anode, and a 20 μm-thick GDC electrolyte after 500 hours aging at 550° C. FIG. 7E shows long-term galvanostatic (0.2 A/cm²) stability and derived PPD of the SOC with PSC-infiltrated Pr-Sm-GDC porous layer, an Ni-GDC anode, and a 20 μm-thick GDC electrolyte at 550° C.

FIG. 7F shows the total and deconvoluted ohmic and electrode ASR over time of the SOC with PSC-infiltrated Pr-Sm-GDC porous layer, an Ni-GDC anode, and a 20 μm-thick GDC electrolyte after 500 hours aging at 550° C.

FIG. 8A shows EIS spectra at OCV for various operation temperatures for an SOC with PSC-infiltrated 5Pr-5Sm-90GDC with 10 wt % PMMA, an Ni-GDC anode, and a 10 μm-thick GDC electrolyte with pO₂=1 atm on the cathode side.

FIG. 8B shows deconvoluted impedance values at open circuit voltage (OCV) over a variety of temperatures with 100 standard cubic centimeters per minute (sccm) O₂ and 100 sccm H₂ flowing to the cathode and anode, respectively, for the SOC with PSC-infiltrated 5Pr-5Sm-90GDC with 10 wt % PMMA, an Ni-GDC anode, and a 10 μm-thick GDC electrolyte.

FIG. 8C shows current-voltage characteristics for the SOC with PSC-infiltrated 5Pr-5Sm-90GDC with 10 wt % PMMA, an Ni-GDC anode, and a 10 μm-thick GDC electrolyte at different operating temperatures.

FIG. 8D shows the current response of the SOC under potentiostatic aging at 0.75 V and periodic measurements of the open circuit voltage (OCV) with PSC-infiltrated 5Pr-5Sm-90GDC with 10 wt % PMMA, an Ni-GDC anode, and a 10 μm-thick GDC electrolyte at 600° C.

FIG. 9A is an Arrhenius plot of non-ohmic ASR for substitution for Sr in the Pr-Sr-Co infiltration (Pr-X-Co) of a 5Pr-5Sm-90GDC porous layer with 10 wt % PMMA in a symmetrical cell, as well as an LSCF-GDC composite cathode in a symmetrical cell for reference.

FIG. 9B is an Arrhenius plot of non-ohmic ASR for substitution for Co in the Pr-Sr-Co infiltration (Pr-Sr-X) of a 5Pr-5Sm-90GDC porous layer with 10 wt % PMMA in a symmetrical cell, as well as an LSCF-GDC composite cathode for reference.

FIG. 9C shows ASR aging for substitution for Sr in the Pr-Sr-Co infiltration (Pr-X-Co) of a 5Pr-5Sm-90GDC porous layer with 10 wt % PMMA in a symmetrical cell.

FIG. 9D shows ASR aging for substitution for Co in the Pr-Sr-Co infiltration (Pr-Sr-X) of a 5Pr-5Sm-90GDC porous layer with 10 wt % PMMA in a symmetrical cell.

FIGS. 10A-10B show current-voltage characteristics at 550° C. and 500° C., respectively, for SOCs with a cathode of 5Pr-5Sm-90GDC porous layer having different porosities, an Ni-GDC anode, and a 20 μm-thick GDC electrolyte.

FIGS. 10C-10D show EIS spectra at 550° C. and 500° C., respectively, for SOCs with a cathode of 5Pr-5Sm-90GDC porous layer having different porosities, an Ni-GDC anode, and a 20 μm-thick GDC electrolyte.

FIG. 10E shows PPD as a function of calculated void fraction for SOCs with a cathode of 5Pr-5Sm-90GDC porous layer, an Ni-GDC anode, and a 20 μm-thick GDC electrolyte.

FIGS. 10F-10G show deconvoluted ASR at 500° C. and 550° C., respectively, as a function of calculated void fraction for SOCs with a cathode of 5Pr-5Sm-90GDC porous layer, an Ni-GDC anode, and a 20 μm-thick GDC electrolyte.

FIG. 11A is an SEM image of a cross-section of a porous functional layer in a fabricated SOC.

FIG. 11B shows current-voltage characteristics for SOCs with and without a porous functional layer at 500° C. and 550° C.

FIG. 11C shows EIS spectra for SOCs with and without a porous functional layer at 550° C.

FIG. 11D shows EIS spectra for SOCs with and without a porous functional layer at 500° C.

FIG. 12A shows ionic transference number versus operating temperature for a 200 μm GDC layer with and without 10 μm porous functional layers.

FIG. 12B shows open circuit voltage (OCV) versus operating temperature for an SOC with a 20 μm GDC layer and porous functional layers (PFL) of different thicknesses compared to an SOC with 20 or 200 μm dense GDC layer and no PFL, illustrating how each approaches OCV for various electrolyte ionic transference numbers.

FIG. 12C shows ohmic resistance and OCV at 500° C. and 600° C. for a GDC electrolyte layer of different thicknesses paired with a 10 μm porous functional layer (with 0.5 wt % PrO₂-x).

FIG. 12D shows OCV versus temperature for different Pr doping levels in a 10 μm porous functional layer on a 10 μm dense electrolyte layer and how each approach OCV for various electrolyte ionic transference numbers.

FIG. 13A is a Nyquist plot for an SSC-GDC cathode symmetrical cell with a porous functional layer having varying Pr doping levels at 500° C.

FIG. 13B shows Arrhenius behavior of a symmetrical cell with only porous functional layers.

FIG. 13C shows Arrhenius behavior of SSC-GDC symmetrical cells without and with porous functional layers.

FIG. 13D shows DRT analysis for an SSC-GDC cathode symmetrical cell with a porous functional layer having varying Pr doping levels at 500° C.

FIG. 13E shows oxygen partial pressure (pO₂) dependent behavior comparing an SSC-GDC cathode layer with or without porous functional layer at 500° C.

FIG. 13F shows DRT analysis for an SSC-GDC cathode layer without and with porous functional layers.

FIGS. 14A-14B show current-voltage characteristics and EIS spectra, respectively, of an SOFC of Pr-surface-modified (SM) SSC-GDC cathode, porous functional layer, GDC electrolyte layer, and Ni-GDC anode, and a SOFC of SSC-GDC cathode, porous functional layer, GDC electrolyte layer, and Ni-GDC anode at 500° C.

FIG. 14C shows galvanostatic and PPD aging results for an SOFC of Pr-surface-modified (SM) SSC-GDC cathode, porous functional layer, GDC electrolyte layer, and Ni-GDC anode at 500° C. and a SOFC of SSC-GDC cathode, porous functional layer, GDC electrolyte layer, and Ni-GDC anode at 550° C.

FIG. 14D shows ASR change over time for the SOFC of Pr-surface-modified (SM) SSC-GDC cathode, porous functional layer, GDC electrolyte layer, and Ni-GDC anode at 500° C.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about” is recited. Whenever “substantially.” “approximately.” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper.” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Introduction

Disclosed herein are enhanced performance SOCs and methods for fabrication thereof. In some embodiments, multiphase electrocatalysts can be infiltrated into a porous layer on an air-side (e.g., oxygen-side) of a solid electrolyte to serve as an air-side electrode. By appropriate control of the fabrication process, SOCs with enhanced performance can be achieved. For example, in some embodiments, the air-side porous layer (configured as an air-side electrode, such as a cathode of an SOFC) is sintered at a temperature less than a first threshold temperature (e.g., 1000° C.) and/or greater than a second threshold temperature (e.g., 900° C.) to achieve a minimum ASR. Alternatively or additionally, in some embodiments, the air-side porous layer can be infiltrated with one or more electrocatalysts, and their calcining and operating temperatures maintained below 650° C., thereby maintaining a nanoscale size that maintains high activity and durability. Alternatively or additionally, in some embodiments, one or more additives (e.g., lanthanide, at a total loading of 10 wt % or less) can be introduced during the fabrication of the air-side porous layer (e.g., mixed with precursors prior to sintering) to increase electronic conductivity, decrease ohmic loss, and/or increase PPD.

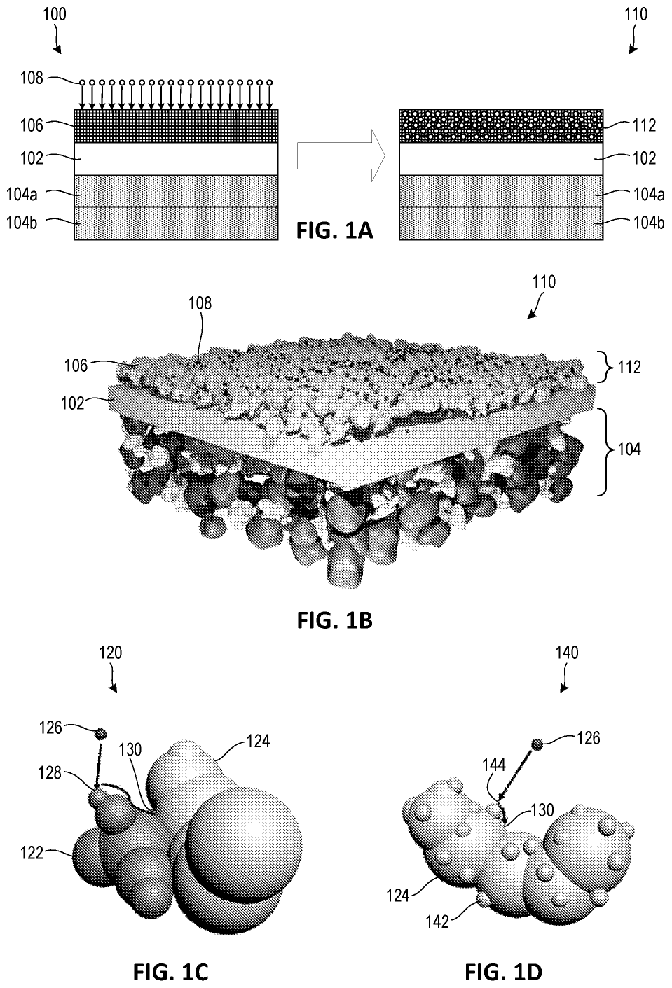

For example, FIGS. 1A-1B illustrate an SOC 110 that has at least one first porous layer 112 (e.g., serving as an air-side electrode), a nonporous oxide layer 102 (also referred to herein as a dense electrolyte layer, or DEL), and one or more second porous layers 104 (e.g., serving as a fuel-side electrode). The first porous layer 112 can be formed to serve as an electrode by infiltrating a porous scaffold 106 of a sintered layer assembly 100 with one or more electrocatalytic oxides 108 (e.g., multiphase electrocatalysts). In some embodiments, the first porous layer 112 can have a thickness less than or equal to 20 μm, for example, in a range of 10-20 μm, inclusive. In the illustrated example of FIG. 1A, a pair of second porous layers is illustrated—a support layer 104b (e.g., anode support layer) and a functional layer 104a(e.g., anode functional layer). In some embodiments, a total thickness of the one or more second porous layers 104a, 104b can be at least 300 μm. Although four layers are shown in FIG. 1A, fewer layers or additional layers are also possible according to one or more contemplated embodiments.

The nonporous oxide layer 102 can operate as a solid electrolyte by conducting oxygen ions therethrough but without substantial conduction of electrons therethrough. For example, an electronic conductivity of the nonporous oxide layer can be less than 25% of an ionic conductivity of the nonporous oxide layer. In some embodiments, the nonporous oxide layer can have a density greater than that of each of the first and second porous layers. Alternatively or additionally, each of the first and second porous layers can have an electronic conductivity that is greater than 25% of an ionic conductivity of the respective porous layer. For example, each of the first and second porous layers can have both high ionic conductivity and high electronic conductivity.

FIGS. 1C-1D illustrate a two-step oxygen transport mechanism for a composite electrode and an electrocatalyst-infiltrate electrode, respectively. In the composite electrode configuration 120 of FIG. 1C, the dissociative adsorption 128 of oxygen 126 occurs on the surface of the first component 122 (e.g., SSC), but requires a long transport distance to the active site 130 on the second component 124 (e.g., GDC). The long transport distance can limit the number of active sites. In contrast, in the infiltrated porous layer configuration 140 of FIG. 1D, the nanoscale electrocatalysts 142 (e.g., PSC) provide a larger number of active sites 144 for oxygen surface exchange as well as a shorter diffusion length between the nanoscale electrocatalyst 142 and nearby scaffold 124, leading to reduction in associated energy loss.

In some embodiments, the at least one first porous layer 112 (e.g., porous scaffold 106) can be formed of ceria or bismuth oxide. For example, the first porous layer 112 can be formed of doped ceria, a cubic bismuth oxide, a rhombohedral bismuth oxide, or a doped rhombohedral bismuth oxide. In some embodiments, a material composition of the first porous layer 112 is one of gadolinia doped ceria (GDC), samaria doped ceria (SDC), samaria-neodymium doped ceria (SNDC), erbia stabilized bismuth oxide (ESB), dysprosium tungsten stabilized bismuth oxide (DWSB), or yttria stabilized bismuth oxide (YSB). Alternatively, in some embodiments, the first porous layer 112 comprises one of the rhombohedral bismuth oxide materials disclosed in U.S. Publication No. 2020/0036028, entitled “Stable high conductivity oxide electrolyte.” and published Jan. 30, 2020, which materials are incorporated herein by reference. For example. the rhombohedral bismuth oxide can be selected from the group consisting of LaY-Bi₂O₃, LaSm-Bi₂O₃, SrY.Bi₂O₃, Nd-Bi₂O₃, LaEr-Bi₂O₃, NdDy-Bi₂O₃, Nd-Bi₂O₃, Sm-Bi₂O₃, NdSm-Bi₂O₃, NdGd-Bi₂O₃, and CaGd-Bi2O₃.

In some embodiments, the at least one first porous layer 112 (e.g . . . porous scaffold 106) can be formed of doped ceria with one or more lanthanides added. For example, the added one or more lanthanides can be praseodymium, samarium, or both praseodymium and samarium. In some embodiments, the total amount of lanthanide additions can be in a range from about 0 wt % to about 20 wt %, for example, from about 0.5 wt % to about 10 wt %. In some embodiments, each lanthanide addition can be about 5 wt %. In some embodiments. the amount of lanthanide addition can be about 10 wt % or less of the total metal content. in which case the total amount of ceria can be at least 90 wt %.

In some embodiments, the at least one first porous layer 112 (e.g., porous scaffold 106) can be a composite material formed of (i) ceria or bismuth oxide with (ii) one or more electronically-conducting and electrocatalytic oxides. Alternatively or additionally, in some embodiments, the at least one first porous layer 112 (e.g., porous scaffold 106) can be formed of one or more materials selected from the group consisting of lanthanum strontium cobalt oxide (LSC), lanthanum strontium cobalt ferrite (LSCF), yttria stabilized zirconia (YSZ), scandia stabilized zirconia (SSZ), gadolinia doped ceria (GDC), samaria doped ceria (SDC), samaria-neodymium doped ceria (SNDC), erbia stabilized bismuth oxide (ESB), dysprosium tungsten stabilized bismuth oxide (DWSB), yttria stabilized bismuth oxide (YSB), rhombohedral bismuth oxide, strontium and magnesium doped lanthanum gallate (LSGM), strontium samarium cobalt oxide (SSC), barium strontium cobalt iron oxide (BSCF), samarium strontium cobalt iron oxide (SSCF), lanthanum strontium manganate (LSM), and Ln₂NiO_{4+δ} nickelate where Ln is a lanthanide.

In some embodiments, the electrocatalysts 108 for infiltration of the porous scaffold 106 can comprise one or more electrocatalytic oxides. For example, the one or more electrocatalytic oxides can comprise one or more MOx, where M is cation such as, but not limited to, Pr, Ca, Sr, Y, La, Nd, Sm, Dy, Er, Mn, Fe, Co, Ni, Cu, and Zn. In some embodiments, the infiltration of the electrocatalysts 108 into the porous scaffold 106 can provide a loading less than or equal to about 60 μmol/cm² of active area, for example, in a range of about 9 μmol/cm² to about 58 μmol/cm², inclusive. Alternatively or additionally, the solution-based loading of electrocatalysts can be less than or equal to 60 μL/cm², for example, in a range of about 19 μL/cm² to about 58 μL/cm². The loading can be dependent on the composition of the electrocatalysts as well as thickness of the porous scaffold, and thus other loading ranges may be applicable in some embodiments.

In some embodiments, the electrocatalysts can comprise at least A and B. In some embodiments, a molar ratio of A:B in the electrocatalysts can be about 1:1. In some embodiments, A can be a Group 2 clement, a Group 3 element, or a lanthanide. Alternatively or additionally, in some embodiments, A can be selected from a group consisting of Pr, Ca, Sr, Y, La, Nd, Sm, Dy, and Er. In some embodiments, B can be a Period 4 element. Alternatively or additionally, in some embodiments, B can be selected from a group consisting of Mn, Fe, Co, Ni, Cu, and Zn.

Alternatively or additionally, in some embodiments, the electrocatalysts can comprise at least Pr. A, and B. In some embodiments, a molar ratio of Pr:A:B in the electrocatalysts can be about 1:1:2. In some embodiments, A can be a Group 2 element, a Group 3 element, or a lanthanide other than Pr. Alternatively or additionally, in some embodiments, A can be selected from a group consisting of Ca, Sr, Y, La, Nd, Sm, Dy, and Er. In some embodiments, B can be a Period 4 element. Alternatively or additionally, in some embodiments, B can be selected from a group consisting of Mn, Fe, Co, Ni, Cu, and Zn.

In some embodiments, the nonporous oxide layer 102 can be formed of ceria, zirconia, bismuth oxide, or lanthanum gallate. In some embodiments, the nonporous oxide layer 102 can include one or more dopants and/or one or more stabilizers. For example, in some embodiments, the materials that can used for the nonporous oxide layer 102 can include, but are not limited to, yttria stabilized zirconia (YSZ.), scandia stabilized zirconia (SSZ), gadolinia doped ceria (GDC), samaria doped ceria (SDC), samaria-neodymium doped ceria (SNDC), erbia stabilized bismuth oxide (ESB), yttria stabilized bismuth oxide (YSB), rhombohedral bismuth oxide, strontium and magnesium doped lanthanum gallate (LSGM), and combinations thereof. In some embodiments, the nonporous oxide layer 102 is formed of a same material as the porous scaffold 106, for example, GDC.

In some embodiments, the one or more second porous layers 104 (e.g., support layer 104b and/or functional layer 104a) can be formed of a nickel-cermet of ceria, a nickel-cermet of zirconia, or a mixed ionic electronic conducting oxide (MIEC), such as, but not limited to, a nickel-cermet of ceria, a nickel-cermet of zirconia, nickel-cermet of gallate, a molybdate, a nickel-cermet of molybdate, a chromate, a nickel-cermet of chromate, a vanadate, or a nickel-cermet of vanadate. In some embodiments, the one or more second porous layers 104 can comprise one of the chromate based oxide materials disclosed in U.S. Pat. No. 11,228,039, entitled “Chromate based ceramic anode materials for solid oxide fuel cells.” and published Jan. 18, 2022, which materials are incorporated herein by reference. For example, the chromate based oxide can be selected from the group consisting of Y_{0.7}Ca_{0.3}Cr_{0.8}Cu_{0.2}O_{3-δ}, Nd_{0.7}Ca_{0.3}Cr_{0.8}Cu_{0.2}O_{3-δ}, (Y_{0.5}Nd_{0.5})_{0.7}Ca_{0.3}Cr_{0.8}Cu_{0.2}O_{3-δ}, Pr_{0.7}Ca_{0.3}Cr_{0.8}Cu_{0.2}O_{3-δ}, and La_{0.6}Sr_{0.4}Cr_{0.9}Mo_{0.1}O_{3-δ}. In some embodiments, one or more second porous layers 104 can comprise one of the strontium iron cobalt molybdenum oxide (SFCM) materials disclosed in U.S. Pat. No. 10,938,052, entitled “Alternative anode material for solid oxide fuel cells,” and published Mar. 2, 2021, which materials are incorporated herein by reference. For example, the SFCM material can have a formula of SrM¹ₓM²_{((1-x)/2)}Mo_{((1-x)/2)}O_{3±δ}, where M¹ and M² are different transition metals and are not Mo, x is about 0.1-0.5, and δ is about 0-1.5. For example, in some embodiments, M¹ is Fe, and M² is Co.

In some embodiments, an enhanced performance SOC can be obtained by providing a porous functional layer (PFL) between an air-side electrode and the solid electrolyte. In some embodiments, the PFL can increase exposure of the nonporous oxide layer to a higher oxygen partial pressure (pO₂), thereby limiting the electronic conductivity of the nonporous oxide layer and mitigating any leakage current therein, and/or increase the effective ionic transference number, t_{O}_{^{2−}}.

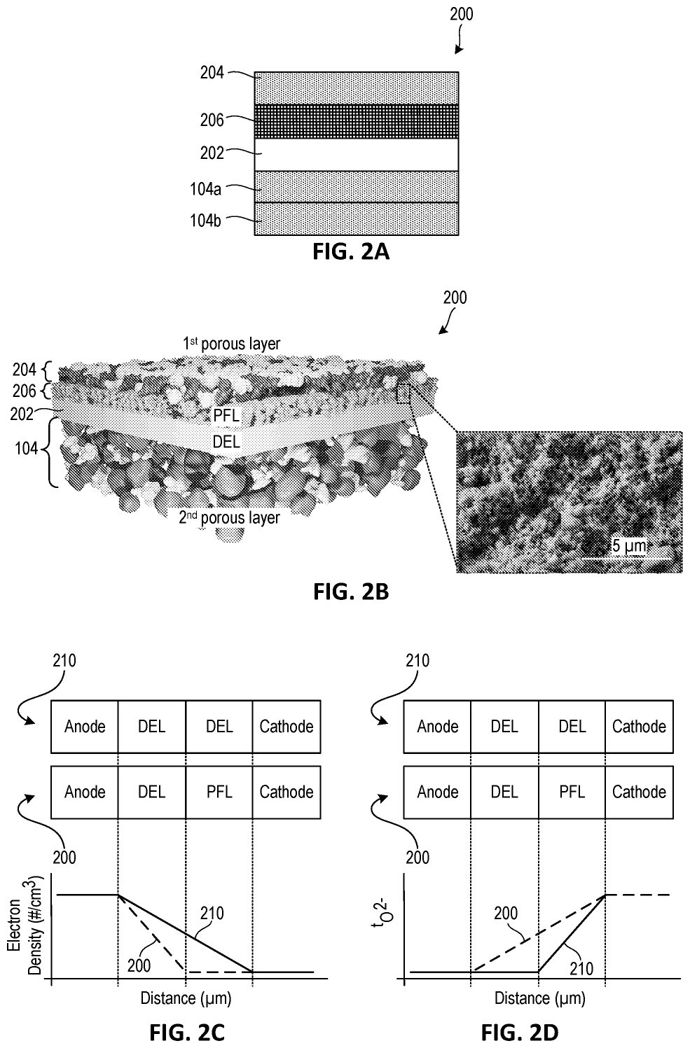

For example, FIGS. 2A-2B illustrate an SOC 200 that has at least one first porous layer 204 (e.g., serving as an air-side electrode), a PFL 206, a nonporous oxide layer 202 (also referred to as DEL), and one or more second porous layers 104 (e.g., serving as a fuel-side electrode). In some embodiments, the PFL 206 is disposed between and in direct contact with the nonporous oxide layer 202 and the first porous layer 204. In some embodiments, the PFL 206 can have a thickness less than or equal to 20 μm, for example, in a range of 10-20 μm, inclusive. Alternatively or additionally, in some embodiments, the nonporous oxide layer 202 can have a thickness less than or equal to 20 μm, for example, in a range of 10-20 μm, inclusive. Alternatively or additionally, in some embodiments, a combined thickness of the PFL 206 and the nonporous oxide layer 202 can be less than or equal to 40 μm. In the illustrated example of

FIG. 2A, a pair of second porous layers is illustrated—a support layer 104b (e.g., anode support layer) and a functional layer 104a (e.g., anode functional layer). In some embodiments, a total thickness of the one or more second porous layers 104a, 104b can be at least 300 μm. In some embodiments, a material composition for the one or more second porous layers 104 can be similar to that described above with respect to the SOC 110 of FIGS. 1A-1C. Although five layers are shown in FIG. 2A, fewer layers or additional layers are also possible according to one or more contemplated embodiments.

Similar to the nonporous oxide layer 102 of FIG. 1A, the nonporous oxide layer 202 of SOC 200 can operate as a solid electrolyte by conducting oxygen ions therethrough but without substantial conduction of electrons therethrough. For example, an electronic conductivity of the nonporous oxide layer 202 can be less than 25% of an ionic conductivity of the nonporous oxide layer. In some embodiments, each of the first and second porous layers can have an electronic conductivity that is greater than 25% of an ionic conductivity of the respective porous layer. For example, the first porous layer 204 and second porous layers 104 can have high ionic conductivity and high electronic conductivity.

In some embodiments, the nonporous oxide layer 202 can have a density greater than that of the PFL 206. In some embodiments, the PFL 206 can be effective to increase an ionic transference number of the nonporous oxide layer 202 and the PFL 206, for example, to at least 0.9 at a temperature less than or equal to 550° C. In some embodiments, the PFL 206 can increase an open circuit voltage (OCV) of the SOC 200 and/or decrease an impedance of the SOC 200. For example, in some embodiments, SOC 200 incorporating PFL 206 can have an OCV of at least 0.90 V at a temperature in a range of 500-550° C.

For materials like doped ceria, dominant defects can be controlled by the oxygen level, x, in Ce(Gd)O₂₋ₓ. These defects are the main charge carriers that determine the electronic and ionic conductivity. In reducing conditions, the reduction of Ce⁴⁺ to Ce³⁺ significantly increases the electronic conductivity. From the solid-state chemistry point of view, as pO₂ decreases, the electron charge carrier concentration, n, increases with x to accommodate the formation of positively charged oxygen vacancies. In contrast, in the high pO₂ regime, the high oxygen chemical potential maintains a low level of x, and thus limits the electronic conductivity of doped ceria.

FIGS. 2C-2D shows theoretical electron charge carrier density and t_{O}_{^{2−}}, respectively. versus distance for an SOC 200 with PFL 206 and an SOC 210 without any PFL, where the areas under the respective curves represent the relative electron charge carrier concentration and average transference numbers in the electrolytes, respectively. For SOC 200, oxygen molecules can freely diffuse through the pores and a homogeneous pO₂ (and thus stoichiometry) of the PFL can be achieved. Therefore, the entire PFL has a constant defect concentration as it is exposed to the same environment, (e.g., pO₂=0.21 atm). In other words, the porous design of the PFL pins the oxygen chemical potential at the PFL-DEL interface to equilibrate with the oxygen gas partial pressure, thereby limiting reduction (e.g., Ce reduction).

In contrast, for the case with only a nonporous oxide layer 102 (DEL), the oxygen gas environment only extends to the cathode/electrolyte interface. For the SOC 200 with PFL 206, the oxygen chemical potential boundary condition of the cathode gas environment can be extended from the cathode/electrolyte interface to the DEL/PFL interface because of the porous nature of the PFL. This change provides an extended electrolytic region significantly lower in electron charge carrier density, as shown in FIG. 2C. As a result, the effective t_{O}_{^{2−}} increases, as shown in FIG. 2D. This enhancement in ionic/electronic conductivity ratio can significantly improve the efficiency of the nonporous oxide layer (e.g., ceria-based electrolyte). In addition, since the PFL extends the cathodic pO₂ throughout its structure, it can provide an opportunity to utilize the higher t_{O}_{^{2−}} of Pr-doped ceria in this structure without the negative effect on ionic conductivity of having Pr on low pO₂ side of a dense electrolyte.

In some embodiments, the nonporous oxide layer 202 can be formed of ceria or bismuth oxide. In some embodiments, the nonporous oxide layer 202 can include one or more dopants and/or one or more stabilizers. For example, in some embodiments, the materials that can used for the nonporous oxide layer 202 can include, but are not limited to. GDC, samaria doped ceria SDC, samaria-neodymium doped ceria SNDC, erbia stabilized bismuth oxide ESB, yttria stabilized bismuth oxide YSB, rhombohedral bismuth oxide, and combinations thereof. In some embodiments, the nonporous oxide layer 202 is formed of a same material as the PFL 206, for example. GDC.

In some embodiments, the at least one first porous layer 204 can be a composite material formed of (i) ceria or bismuth oxide with (ii) one or more electronically-conducting and electrocatalytic oxides. In some embodiments, the materials for the first porous layer 204 can be a composite having (1) a material selected from the first group consisting of LSCF, BSCF, SSCF, SSC, and LSM and (2) a material selected from the second group consisting of YSZ, SSZ, GDC, SDC, SNCD, ESB, DWSB, YSB, rhombohedral bismuth oxide, and LSGM. For example, the first porous layer 204 can be a composite of SSC-GDC. Alternatively or additionally, in some embodiments, the at least one first porous layer 204 can be formed of one or more materials selected from the group consisting of LSC, LSCF, YSZ, SSZ, GDC, SDC, SNDC, ESB, DWSB, YSB, rhombohedral bismuth oxide, LSGM, SSC, BSCF, SSCF, LSM, and Ln₂NiO_{4+δ} nickelate where Ln is a lanthanide.

In some embodiments, the at least one first porous layer 204 can be infiltrated with and/or surface modified by one or more electrocatalytic oxides. For example, the surface modification may be performed using the methodology described in Huang et al., “Nanointegrated, High-Performing Cobalt-Free Bismuth-Based Composite Cathode for Low-Temperature Solid Oxide Fuel Cells.” ACS Appl. Mater. Interfaces, 2018, 10 (34): pp. 28635-43, which is incorporated herein by reference. For example, the one or more electrocatalytic oxides can comprise one or more MOx, where M is cation such as, but not limited to, Pr, Ca, Sr, Y, La, Nd, Sm, Dy, Er, Mn, Fe, Co, Ni, Cu, and Zn.

Although specific materials and configurations have been discussed above and elsewhere herein, embodiments of the disclosed subject matter are not limited thereto. Rather, other functionally similar materials can be employed for one or more layers of the disclosed SOCs to achieve the same or similar effect, according to one or more contemplated embodiments.

### Solid Oxide Cell Systems

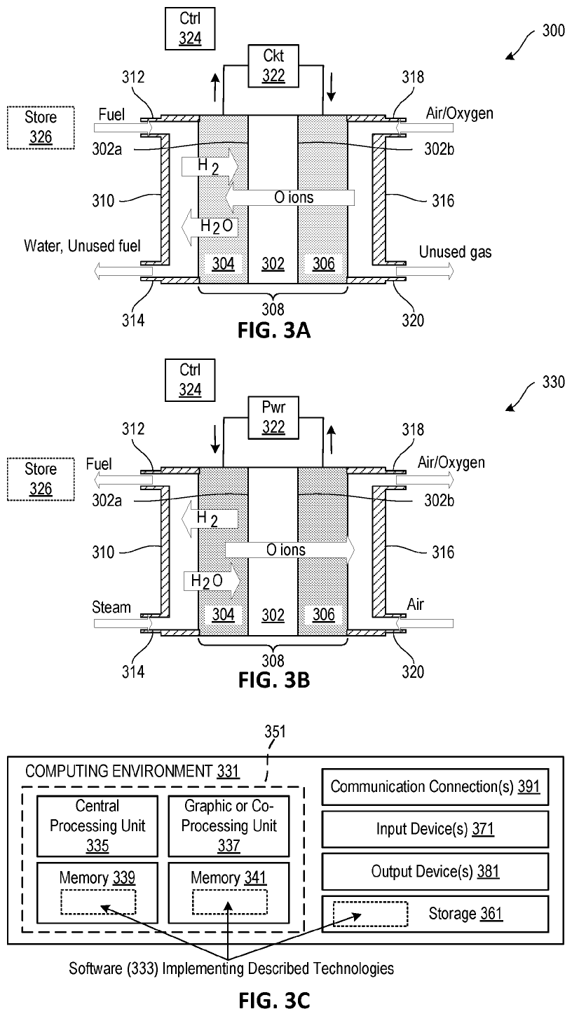

In some embodiments, the SOC 110 of FIGS. 1A-1B or the SOC 200 of FIGS. 2A-2B can be operated as a solid oxide fuel cell (SOFC), the basic operation of which is described in U.S. Pat. No. 9,525,179, entitled “Ceramic anode materials for solid oxide fuel cells,” and published Dec. 20, 2016, which is incorporated by reference herein. For example, FIG. 3A illustrates an SOFC system 300 employing an SOC layer assembly 308 having a solid oxide electrolyte 302 (e.g., nonporous oxide layer 102 or 202), a fuel-side electrode 304 (anode, e.g., second porous layers 104), and an air-side electrode 306 (cathode, e.g., first porous layer 112 or 204). The SOFC system 300 can have an external circuit 322 (e.g., load) and a controller 324, for example, to control operation of system 300. In some embodiments, the SOFC system 300 can include fuel storage 326, from which fuel can be dispensed to generate electricity.

An input stream of air or oxygen containing gas can flow to the air-side electrode 306 via first port 318 of an air-side manifold 316. In some embodiments, the input stream provided to first port 318 can have an oxygen concentration in a range of 20-100% (mole fraction), inclusive. As the air flows past the electrode 306, oxygen atoms in the input stream can be reduced within the electrode 306 to create oxygen ions that flow toward the second side 302b of the electrolyte 302. The oxygen ions travel through the electrolyte 302 and into the electrode 304 at the first side 302a of the electrolyte 302. Any unused gas can exit the manifold 316 via second port 320.

Fuel can flow to the fuel-side electrode 304 via first port 312 of a fuel-side manifold 310. In some embodiments, the fuel provided to first port 312 can include H₂, CO, NH₃, hydrocarbon gases derived from methane, higher hydrocarbons (such as but not limited to gasoline, diesel, biogas, etc.), or any combination thereof. The oxygen ions can react with the fuel at the electrode 304 to oxidize the fuel and generate electrons, which flow from the fuel-side electrode 304, into the electronic circuit 322, and back into the air-side electrode 306. Oxidation products (e.g., water, carbon dioxide, etc.) and/or unused fuel can exit the manifold 310 via second port 314.

Alternatively or additionally, in some embodiments, the SOC 200 of FIGS. 2A-2B can be operated as a solid oxide electrolysis cell (SOEC). For example, FIG. 3B illustrates an SOEC system 330 employing an SOC layer assembly 308 having a solid oxide electrolyte 302 (e.g., nonporous oxide layer 202), a fuel-side electrode 304 (cathode, e.g., second porous layers 104), and an air-side electrode 306 (anode, e.g., first porous layer 204). The SOEC system 300 can have an external circuit 322 (e.g., power supply) and a controller 324, for example, to control operation of system 330. In some embodiments, the SOFC system 330 can include fuel storage 326, into which fuel produced can be stored.

Reactants (e.g., H₂O and/or CO₂) can flow to the fuel-side electrode 304 via second port 314 of a fuel-side manifold 310. Electrons from external circuit 322 can be used to reduce the reactants within the electrode 304, thereby creating oxygen ions that flow toward the first side 302a of the electrolyte 302 as well as fuel (e.g., H₂, CO, etc.). The reaction products and any used reactants can be directed to fuel storage 326 via first port 312 of manifold 310 for later use. Meanwhile, the oxygen ions can travel through the electrolyte 302 and into the electrode 306 at the second side 302b, where it is converted into oxygen molecules, where it can be carried out of the manifold 316 via the flowing air through the first port 318.

Alternatively or additionally, in some embodiments, the SOC can be reversibly operated, for example, operating as SOFC 300 in a first mode of operation (e.g., to generate electricity from a fuel) and reversing polarity (e.g., of circuit 322) to operate as SOEC 330 in a second mode of operation (e.g., to store energy in a fuel).

### Fabrication of Solid Oxide Cells

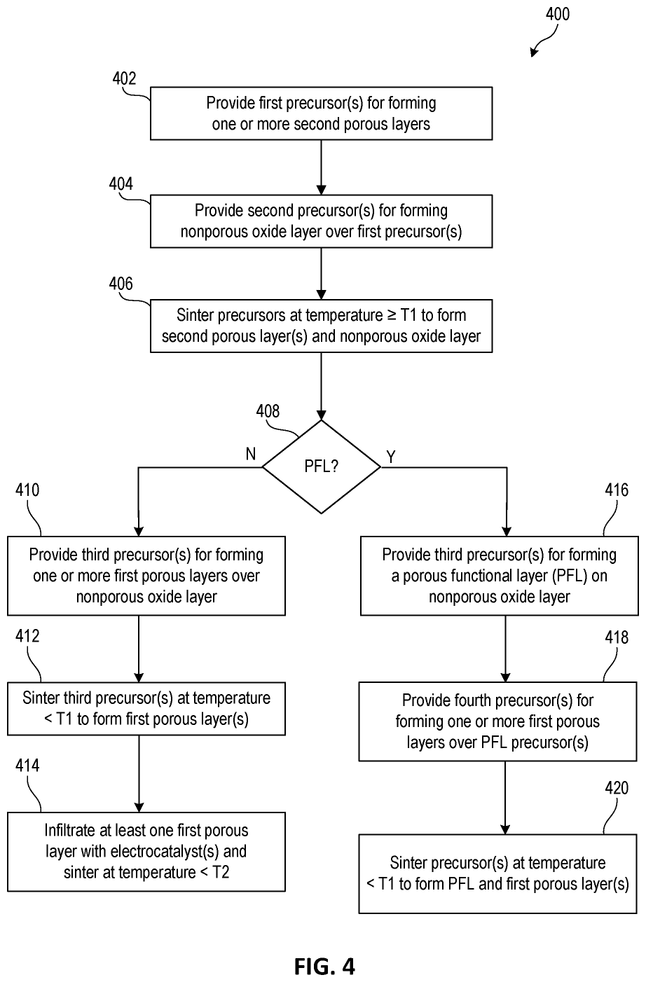

FIG. 4 shows an exemplary method 400 for fabricating a SOC, for example, SOC 110 of FIGS. 1A-1B or SOC 200 of FIGS. 2A-2B. The method 400 can begin at process block 402, where one or more first precursors are provided for forming one or more second porous layers (e.g., a fuel-side porous layer, such as layer 104a and/or 104b in FIG. 1A or FIG. 2A). In some embodiments, the provision of process block 402 can include tape casting, blade coating, laminating, screen printing, or any combination thereof. The one or more first precursors may include precursors that can form any of the above noted materials for the second porous layer upon sintering in process block 406. For example, the provision of process block 402 can include mixing nickel oxide and GDC together in a first slurry, and then tape casting to form a first precursor layer. In some embodiments, the one or more first precursors can include a pore former, for example, PMMA particles (e.g., have a diameter of ˜1.5 μm) at a loading of 0-15 wt %, inclusive. For example, the provision of process block 402 can include mixing the pore former into the first slurry prior to tape casting.

The method 400 can proceed to process block 404, where one or more second precursors are provided for forming the nonporous oxide layer (e.g., layer 102 in FIG. 1A or layer 202 in FIG. 2A). In some embodiments, the provision of process block 404 can include tape casting, blade coating, laminating, screen printing, or any combination thereof. The one or more second precursors may include precursors that can form any of the above noted materials for the nonporous oxide layer upon sintering in process block 406. For example, the provision of process block 404 can include mixing GDC into a second slurry, and then tape casting to form a second precursor layer. Since the nonporous oxide layer is to be formed a dense layer, no pore formers are provided in the second slurry. The one or more second precursors can be provided directly on or over the previously formed first precursor layer, for example, via hot roll lamination.

The method 400 can proceed to process block 406, where the first and second precursors are sintered at a high temperature (e.g., greater than a threshold, T1) to form the one or more second porous layers and the nonporous oxide layer, respectively. In some embodiments, the threshold, T1, is about 1000° C. For example, the sintering of process block 406 can be performed at a temperature of about 1450° C. In some embodiments, the sintering of process block 406 may be for at least an hour, for example, about 4 hours.

The method 400 can proceed to decision block 408, where it is determined if the SOC should include a PFL. If no PFL is desired, the method 400 can proceed to process block 410, where one or more third precursors are provided for forming one or more first porous layers (e.g., layer 106 in FIG. 1A). In some embodiments, the provision of process block 410 can include tape casting, blade coating, laminating, screen printing, or any combination thereof. The one or more third precursors may include precursors that can form any of the above noted materials for the first porous layer upon sintering in process block 412. For example, the provision of process block 410 can include mixing ceria (e.g., GDC) with or without lanthanide additives (e.g., 0.5-5 wt % praseodymium oxide and/or 0.5-5 wt % samarium oxide) into an ink, and then tape casting or blade coating to form a third precursor layer. In some embodiments, the one or more third precursors can include a pore former, for example, PMMA particles (e.g., have a diameter of ˜1.5 um) at a loading of 0-15 wt %, inclusive (e.g., ˜5 wt % PMMA). For example, the provision of process block 410 can include mixing the pore former into the ink prior to tape casting. In some embodiments, the one or more third precursors can be provided directly on or over the previously formed nonporous oxide layer.

The method 400 can proceed to process block 412, where the one or more third precursors can be sintered at a low temperature (e.g., less than the threshold, T1) to form the one or more first porous layers. In some embodiments, the threshold, T1, is about 1000° C. For example, the sintering of process block 412 can be performed at a temperature of about 950° C. In some embodiments, the sintering of process block 412 may be for at least an hour, for example, about 2 hours. In some embodiments, the sintering of process block 412 can include a lower temperature intermediate burnout (e.g., 400° C, for 30 minutes) to burn out the PMMA and binders.

The method 400 can proceed to process block 414, where at least one of the one or more first porous layers can be infiltrated with one or more electrocatalysts (e.g., electrocatalysts 108 in FIG. 1A) and then sintered at an even lower temperature (e.g., less than a threshold, T2, which is less than threshold T1). The one or more electrocatalysts may include any of the above noted materials for the electrocatalysts. In some embodiments, the infiltration can include one or more cycles of vacuum infiltration. For example, electrocatalysts in solution (e.g., nitrate solution) can be disposed on an exposed surface of the first porous layer and subjected to vacuum to encourage infiltration of the solution into the pores of the layer. This may be repeated one or more times with additional solution before calcining to evaporate and/or combust the solvent. For example, the calcining may be done at a temperature <650° C., such as ˜450° C, for 30 minutes. In some embodiments, an infiltration cycle can include at least two solution application and vacuum iterations, followed by heating. In some embodiments, the infiltration cycle can be performed one or more times to achieve a desired electrocatalyst loading.

If it is decided that a PFL should be included in the SOC, the method 400 can proceed from decision block 408 to process block 416, where one or more third precursors are provided for forming the PFL (e.g., layer 206 in FIG. 2A). In some embodiments, the provision of process block 416 can include tape casting, blade coating, laminating, screen printing, or any combination thereof. The one or more third precursors may include precursors that can form any of the above noted materials for the PFL upon sintering in process block 420. For example, the provision of process block 416 can include mixing ceria (e.g., GDC) with or without lanthanide additives (e.g., 0.5-5 wt % praseodymium oxide and/or 0.5-5 wt % samarium oxide) into an ink, and then tape casting or blade coating to form a third precursor layer. In some embodiments, the one or more third precursors can include a pore former, for example, PMMA particles (e.g., have a diameter of ˜1.5 um) at a loading of 0-15 wt %, inclusive (e.g., ˜5 wt % PMMA). For example, the provision of process block 416 can include mixing the pore former into the ink prior to tape casting. In some embodiments, the one or more third precursors can be provided directly on or over the previously formed nonporous oxide layer.

The method 400 can proceed to process block 418, where one or more fourth precursors are provided for forming one or more first porous layers (e.g., an air-side porous layer, such as layer 204 in FIG. 2A). In some embodiments, the provision of process block 418 can include tape casting, blade coating, laminating, screen printing, or any combination thereof. The one or more fourth precursors may include precursors that can form any of the above noted materials for the first porous layer upon sintering in process block 420. For example, the first porous layer can be a composite electrode, and the provision of process block 418 can include mixing two different ceria (e.g., SSC and GDC) into an ink, and then screen printing as a fourth precursor layer directly on or over the previously formed third precursor layer. Alternatively, in some embodiments, the first porous layer may be an infiltrated electrode, in which case an electrocatalyst infiltration (e.g., similar to process block 414) can be performed after the sintering of process block 420.

The method 400 can proceed to process block 420, where the third and fourth precursors are sintered at a low temperature (e.g., less than threshold, T1) to form the PFL and the one or more first porous layers, respectively. In some embodiments, the threshold, T1, is about 1000° C. For example, the sintering of process block 420 can be performed at a temperature of about 950° C. In some embodiments, the sintering of process block 420 may be for at least an hour, for example, about 2 hours.

Although blocks 402-420 of method 400 have been described as being performed once, in some embodiments, multiple repetitions of a particular process block may be employed before proceeding to the next decision block or process block. In addition, although blocks 402-420 of method 400 have been separately illustrated and described, in some embodiments, process blocks may be combined and performed together (simultaneously or sequentially).

Moreover, although FIG. 4 illustrates a particular order for blocks 402-420, embodiments of the disclosed subject matter are not limited thereto. Indeed, in certain embodiments, the blocks may occur in a different order than illustrated or simultaneously with other blocks. In some embodiments, method 400 may comprise only some of blocks 402-420 of FIG. 4.

### Computer Implementation

FIG. 3C depicts a generalized example of a suitable computing environment 331 in which the described innovations may be implemented, such as but not limited to aspects of SOC controller 324 or fabrication method 400. The computing environment 331 is not intended to suggest any limitation as to scope of use or functionality, as the innovations may be implemented in diverse general-purpose or special-purpose computing systems. For example, the computing environment 331 can be any of a variety of computing devices (e.g., desktop computer, laptop computer, server computer, tablet computer, etc.).

With reference to FIG. 3C, the computing environment 331 includes one or more processing units 335, 337 and memory 339, 341. In FIG. 3C, this basic configuration 351 is included within a dashed line. The processing units 335, 337 execute computer-executable instructions. A processing unit can be a central processing unit (CPU), processor in an application-specific integrated circuit (ASIC), or any other type of processor (e.g., hardware processors, graphics processing units (GPUs), virtual processors, etc.). In a multi-processing system, multiple processing units execute computer-executable instructions to increase processing power. For example, FIG. 3C shows a central processing unit 335 as well as a graphics processing unit or co-processing unit 337. The tangible memory 339, 341 may be volatile memory (e.g., registers, cache, RAM), non-volatile memory (e.g., ROM, EEPROM, flash memory, etc.), or some combination of the two, accessible by the processing unit(s). The memory 339, 341 stores software 333 implementing one or more innovations described herein, in the form of computer-executable instructions suitable for execution by the processing unit(s).

A computing system may have additional features. For example, the computing environment 331 includes storage 361, one or more input devices 371, one or more output devices 381, and one or more communication connections 391. An interconnection mechanism (not shown) such as a bus, controller, or network interconnects the components of the computing environment 331. Typically, operating system software (not shown) provides an operating environment for other software executing in the computing environment 331, and coordinates activities of the components of the computing environment 331.

The tangible storage 361 may be removable or non-removable, and includes magnetic disks, magnetic tapes or cassettes, CD-ROMs, DVDs, or any other medium which can be used to store information in a non-transitory way, and which can be accessed within the computing environment 331. The storage 361 can store instructions for the software 333 implementing one or more innovations described herein.

The input device(s) 371 may be a touch input device such as a keyboard, mouse, pen, or trackball, a voice input device, a scanning device, or another device that provides input to the computing environment 331. The output device(s) 371 may be a display, printer, speaker, CD-writer, or another device that provides output from computing environment 331.

The communication connection(s) 391 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### FABRICATED EXAMPLES AND EXPERIMENTAL RESULTS

### Electrocatalyst-Infiltrated Porous Layers as Air-Side Electrodes

Symmetrical cell solid-oxide fuel cells (SOFCs) were produced by using a uniaxial press to press GDC powder to a thickness of 1.5 mm. Button cell SOFCs were produced by laminating a tape-casted anode support, anode functional, and electrolyte materials by hot roll lamination, and subsequently punched-out and sintered. An anode support layer (ASL) was produced by mixing 60 wt % NiO and 40 wt % GDC, with 3 wt % poly(methyl methacrylate) (PMMA) added to the slurry before mixing for porosity. An anode functional layer (AFL) was created by mixing 48 wt % NiO with 52 wt % GDC. The electrolyte dense tape was made using a similar method. A single high-temperature (e.g., >1000° C.) treatment was used to sinter the half-cells produced by roll-roll processing, e.g., dense GDC supported on the Ni-GDC.

Then, a Pr/Sm-lanthanide modified GDC scaffold was produced (e.g., via tape casting and blade coating) and sintered below 1000° C. In particular, scaffold inks were created by mixing Pr₆O₁₁, Sm₂O₃, and GDC powder to their respective compositions by wt % of precursor powder (e.g., 5Pr-GDC is 5 wt % Pr₆O₁₁-95 wt % GDC and so forth). The mixed composition was then ball milled overnight in ethanol. The composition was subsequently mixed with ESL 441 ink vehicle (a texanol-based composition sold by ElectroScience) was mixed with the mixture in a planetary centrifugal mixer until a ratio of ink vehicle to power of 1:1 (by weight) was achieved, and all ethanol had evaporated. For inks with PMMA, Chemisnow® MX-150 PMMA (sold by Soken Chemical & Engineering) was added to the mixture by weight % before ball milling. Inks were sintered on either symmetrical or full cells at 950° C, for 2 hours with an intermediate burnout step (e.g., 400° C, for 30 minutes) to burn out the PMMA and binders.

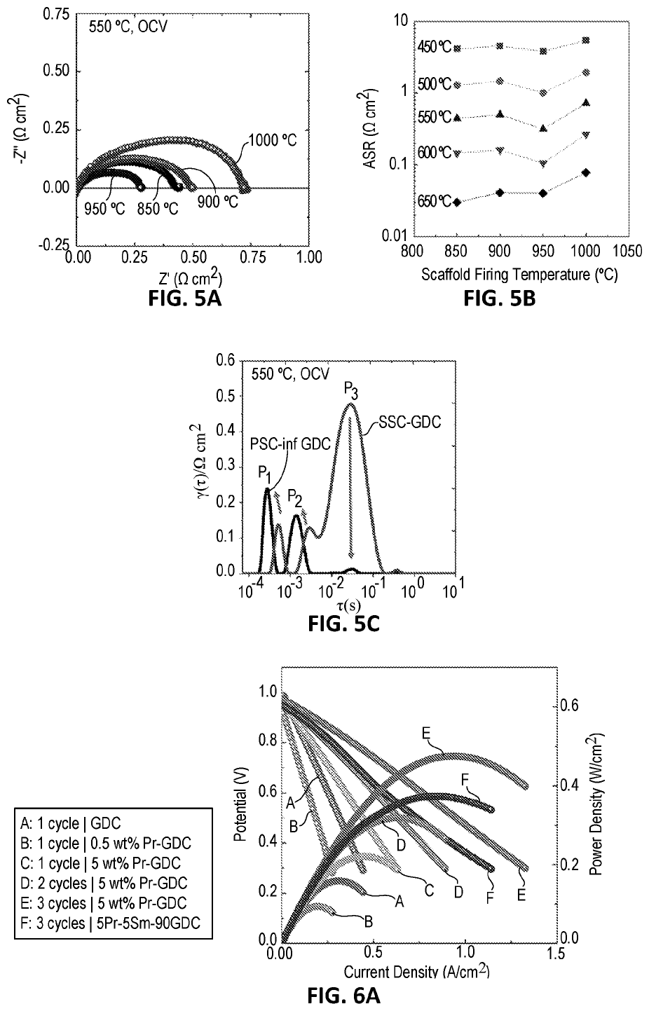

The electrocatalysts were then deposited into the scaffold and treated below 650° C., yielding the complete cell. For example, a PSC multiphase electrocatalyst was synthesized by dissolving Pr-Sr-Co nitrates in a (1-1-2) molar ratio by metal cation. Pr_{0.5}Sr_{0.5}CoO_{3-δ} was the targeted phase. PrCoO₃, Pr_{0.5}Sr_{0.5}CoO_{3-δ}, and Pr_{0.5}Sr_{0.5}CoO_{3-δ} infiltrates were also produced by the same method. The pH of the infiltrate mixture was balanced by adding ammonium hydroxide to the nitrate solution to a final pH of ˜7. In addition, 3 wt % of a nonionic surfactant (e.g., Triton X100, sold by Sigma Aldrich) was combined with NO₃, and the combination added as a surfactant to increase pore wettability. Note that the results shown in FIGS. 5A-5C were obtained using a solution that was not pH balanced and without Triton X100. Cells were infiltrated with 2 μL/0.31cm² and then vacuum dried for ˜15 minutes to increase pore wettability. This infiltration was repeated two times per cycle for a total of 6 μL/0.31cm² of infiltrate per scaffold. The cells were then fired at low temperature (e.g., 450° C, for 30 minutes) to evaporate the nitrate, and the infiltration was repeated to meet the desired loading. Note that 1 infiltration cycle corresponds to one low-temperature firing in the furnace.

Results of the symmetrical cell testing of a PSC mixture on GDC scaffolds are shown in FIGS. 5A- C. In-situ, high-temperature phase analysis of the infiltrated PSC particles suggests the formation of a multi-phase cathode containing PrO_{2-δ}, Co₃O₄ and SrCoO_{3-δ} which are stable up to at least 650° C. Without wishing to be bound by any particular theory, it is believed that the co-existence of these multiple phases in conjunction with the advanced nanostructured morphology contributes to the high electrochemical performance and low ASR. As shown in the Nyquist plot at 550° C. of FIG. 5A, a scaffold firing temperature of 950° C, for the GDC scaffold as the cathode yields an ASR of 0.25 Ωcm², which represents a 50˜75% decrease than the scaffolds fired at higher temperatures. The scaffold sintering temperature effect is summarized in FIG. 5B, which shows a reverse volcano behavior with the lowest ASR at 950° C. Below 950° C., poor sintering leads to a higher ASR; above 950° C., the densification of the scaffold could reduce the triple-phase-boundary length. However, other scaffold compositions may achieve a minimum ASR at sintering temperatures different than 950° C. FIG. 5C shows distribution of relaxation time (DRT) analysis, with the major peaks being labeled P₁-P₃. P₁ and P₂ (τ˜10⁻³ s), which are typically attributed to interfacial charge transfer, slightly increase. In contrast, P₃, which is attributed to the surface exchange reactions, shows a 98% reduction in energy loss compared to the conventional SSC-GDC cathode.

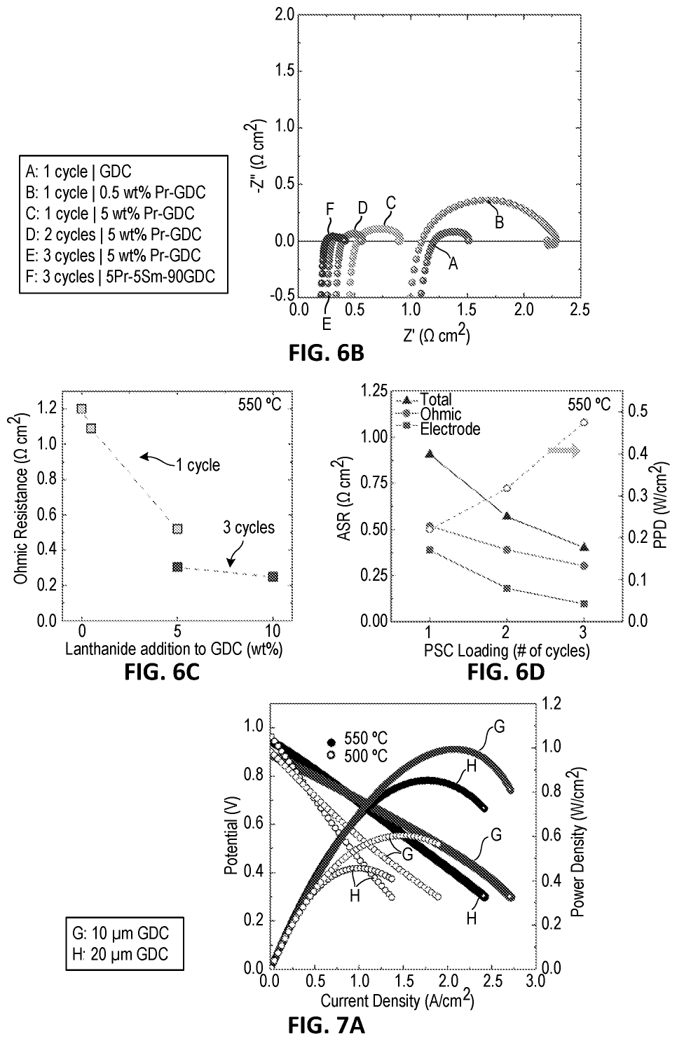

While the example of FIGS. 5A-5C is for a simple GDC scaffold, FIGS. 6A-6D demonstrate the effect of further lanthanide addition (e.g., Pr and/or Sm) to the scaffold. Different ceria-based scaffolds with different PSC loadings (e.g., number of infiltration cycles) were integrated into full cells. The current-voltage (iV) and EIS at 550° C, for these full cells are shown in FIGS. 6A-6B, respectively. For the pure GDC scaffold, the polarization resistance was only 0.25 £2cm², but the low electronic conductivity of cathode leads to a high ohmic ASR of 1.25 Ωcm², thereby limiting the peak power density (PPD) to only 175 mW/cm². Because a 20 μm dense GDC electrolyte typically contributes ˜0.2 Ωcm² at 550° C., the apparent ohmic loss from the scaffold is a substantial ˜1 Ωcm².

However, by modifying the GDC scaffold with the addition of Pr and/or Sm, the ohmic loss can be dramatically reduced and the PPD of the full cell can be improved, as shown in FIG. 6C. In particular, as the Pr/Sm loading increases, the ohmic ASR of full cells (with a 20 μm GDC electrolyte) decreases, suggesting the electronic conductivity of the scaffold increases. With the addition of 0.5 wt % Pr₆O₁₁ to the scaffold (0.5Pr-GDC), the ohmic ASR decreases from 1.25 Ωcm² to 1.1 2cm². Addition of 5 wt % Pr₆O₁₁ (5Pr-GDC) further decreases the ohmic ASR to 0.5 Ωcm². Comparing the 3-cycle-infiltrated-PSC cells, the ohmic ASR dropped from 0.3 to 0.24 Ωcm² at 550° C. when adding 5 wt % Sm203 in addition to the 5 wt % Pr₆O₁₁ (5Pr-5Sm-90GDC). Although the 5Pr-GDC cell has a slightly higher peak power density compared to the 5Pr-5Sm-90GDC cell in this controlled experiment, the 5Pr-5Sm-90GDC contributed the lowest ohmic loss to cell performance. These results suggest that lanthanide addition to GDC scaffold can improve the conductivity, leading to a lower ohmic ASR and a higher performance.

The effect of electrocatalyst loading is summarized in FIG. 6D, where 1 cycle is approximately 1˜2 mg of infiltrated oxide. As the PSC loading increases, the electrode ASR decreases due to the increasing number of active sites. In addition, the ohmic ASR decreases from 0.5 Ωcm² to 0.25 Ωcm² with increased infiltration loading (1 cycle vs 3 cycles). Without wishing to be bound by any particular theory, the ohmic ASR decrease in response to increased loading can be due (1) increased connectivity of conductive electrocatalysts and/or (2) doping of infiltrates into the scaffold during synthesis and/or testing. The decrease in ohmic ASR helps to increase PPD from 0.22 W/cm² for 1 infiltration cycle loading, to 0.5 W/cm² at 550° C, for 3infiltration cycle loading. For more than 3 infiltration cycles, the PSC can begin to agglomerate.

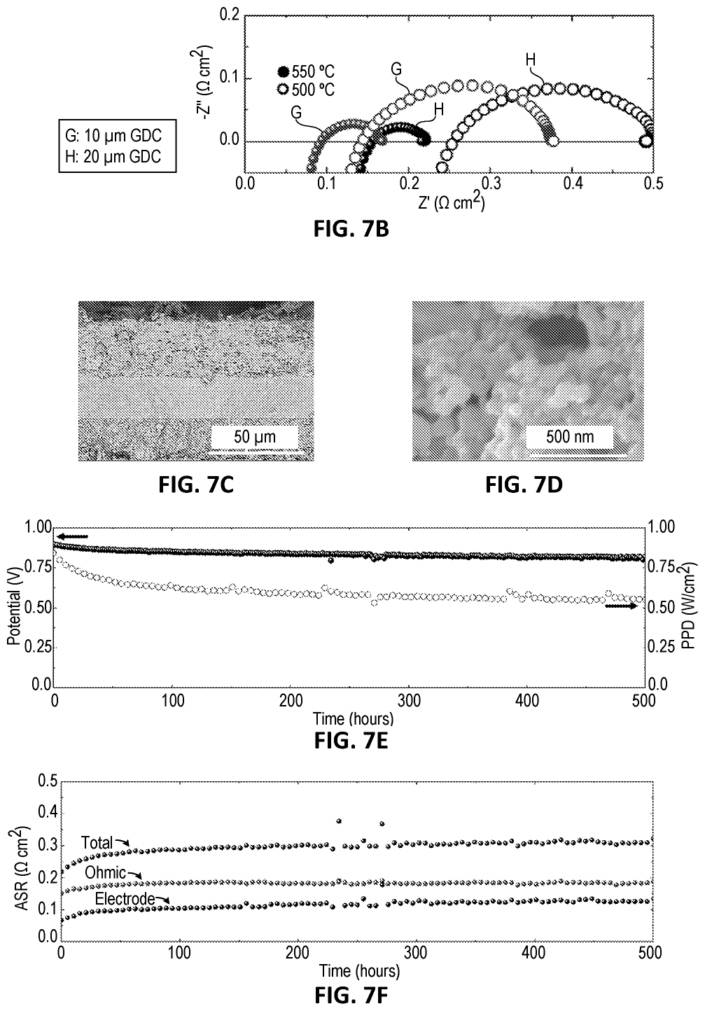

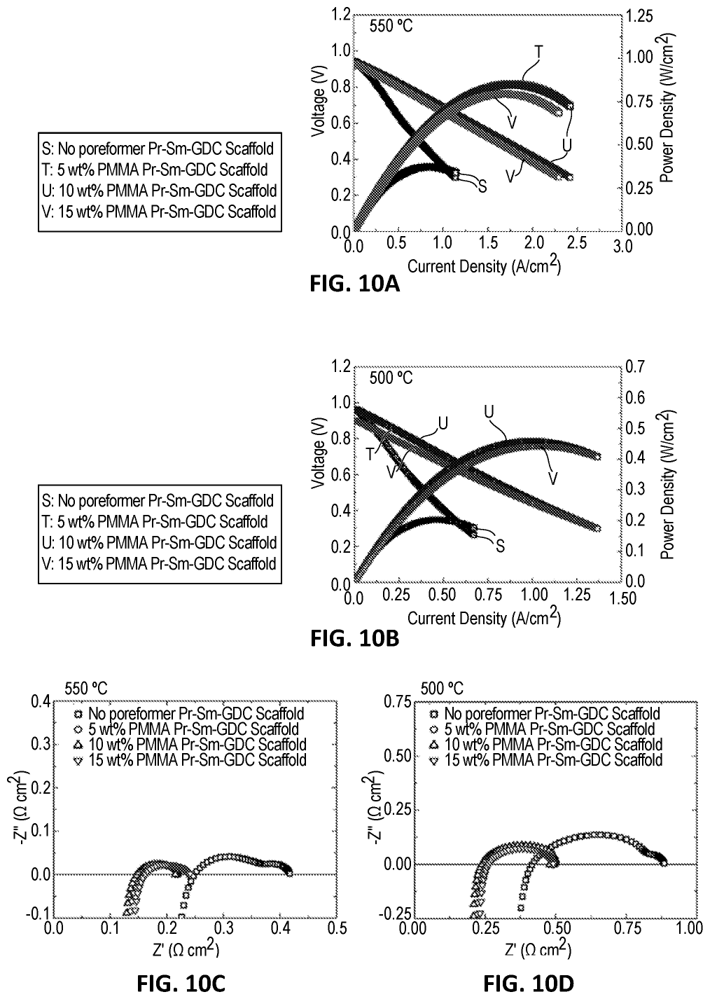

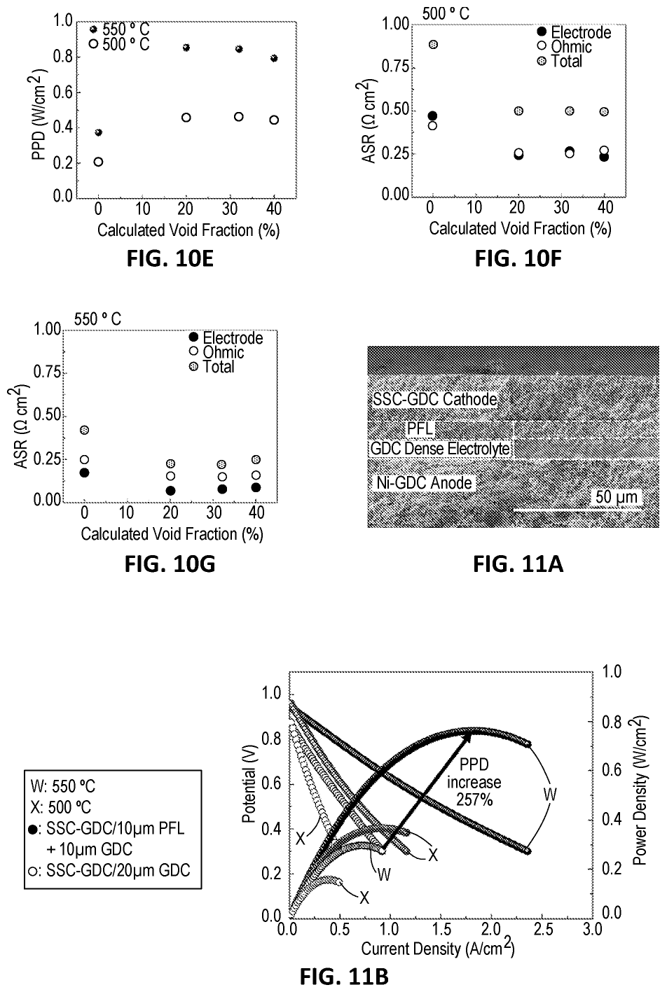

The PSC-infiltrated 5Pr-5Sm-90GDC scaffold was further improved by tuning the electrode microstructure, as shown in FIGS. 10A-10F, and the high-performance results of the optimized cell are shown in FIGS. 7A- 7F. In particular, the porosity of the scaffold increases surface area to allow higher electrocatalyst loading and can resolve mass transfer limitations. Consequently, as shown in FIG. 7A, a 20-μm-electrolyte cell shows a PPD of 0.85 W/cm² at 550° C., and a 10-um-electrolyte cell achieves a PPD of 1 W/cm² at 550° C. and 0.6 W/cm² at 500° C. FIG. 7B shows that the polarization impedance was only ˜0.07 Ωcm². The ohmic part was considered to be the major loss for both cells, e.g., 0.15 52cm² and 0.09 Ωcm² in the 20 μm and 10 μm configurations, respectively.

The microstructure of the aged 20-um-electrolyte cell can be seen in FIG. 7C. As suggested by FIG. 7D, the PSC electrocatalysts exhibit high activity and durability, with their nanoscale state preserved after 500 hours at 550° C. This can be attributed to the infiltrate calcining temperature. In particular, PSC nanoparticles were only subjected to temperatures of 650° C. or less. Prior attempts at infiltration have utilized much higher temperatures (e.g., greater than 800° C.). For example, Pr_{0.4}Sr_{0.6}CoO_{3-δ} on an LSCF-SDC scaffold synthesized at a high temperature of 800-1300° C. produced a cathode ASR of 0.15 2cm² at 750° C. In contrast, the multi-phase PrOₓ, CoOₓ, and SrCoO_{3-δ} mixture of the instant example achieves a low ASR of 0.25 Ωcm² at 550° C. with high durability.

The aging results of the 20-um-electrolyte cell in FIGS. 7E-7F show that the majority of the PPD drop occurs in the first 50 hours. Without wishing to be bound by any particular theory, it is believed that the PPD drop is due to the slight coarsening of PSC nanoparticles. As shown in FIGS. 7C-7D, the size of the PSC particles grew from ˜20 nm initially to ˜100-200 nm after 500 hours. This is further supported by FIG. 7E, as the overall electrode ASR increased from 0.07 Ωcm² (t=0 hrs) to 0.11 Ωcm² (t=50 hrs), and then stabilized for the duration of the experiment (t=500 hours). The ohmic ASR displayed a similar trend, which may be due to the loss in electronic connection because of particle agglomeration. Note that one primary electronic conduction pathway is through the PSC infiltrate particles connected on the surface. Regardless, the long-term galvanostatic testing reveals very little degradation at 200 mA/cm² over the 500-hour long test, especially after the first 50 hours.

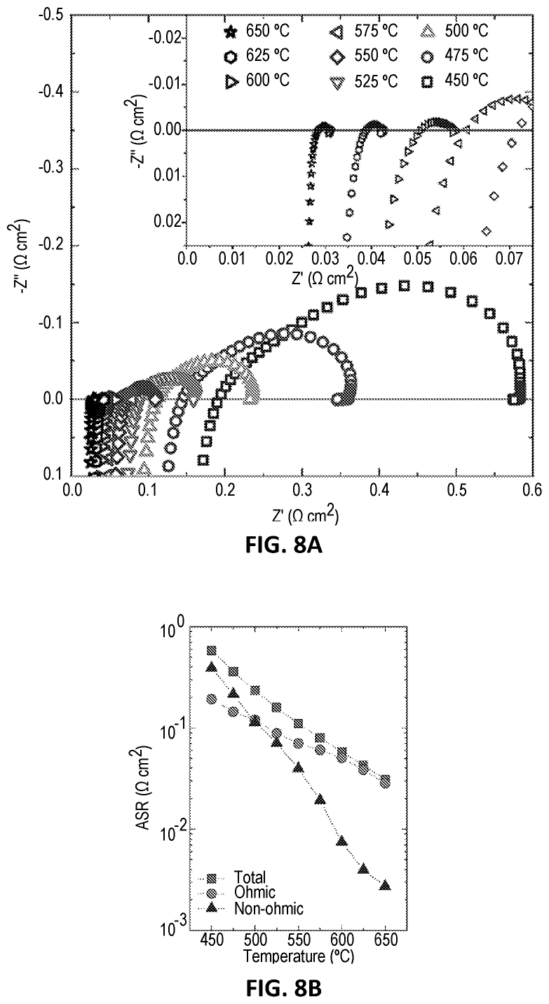

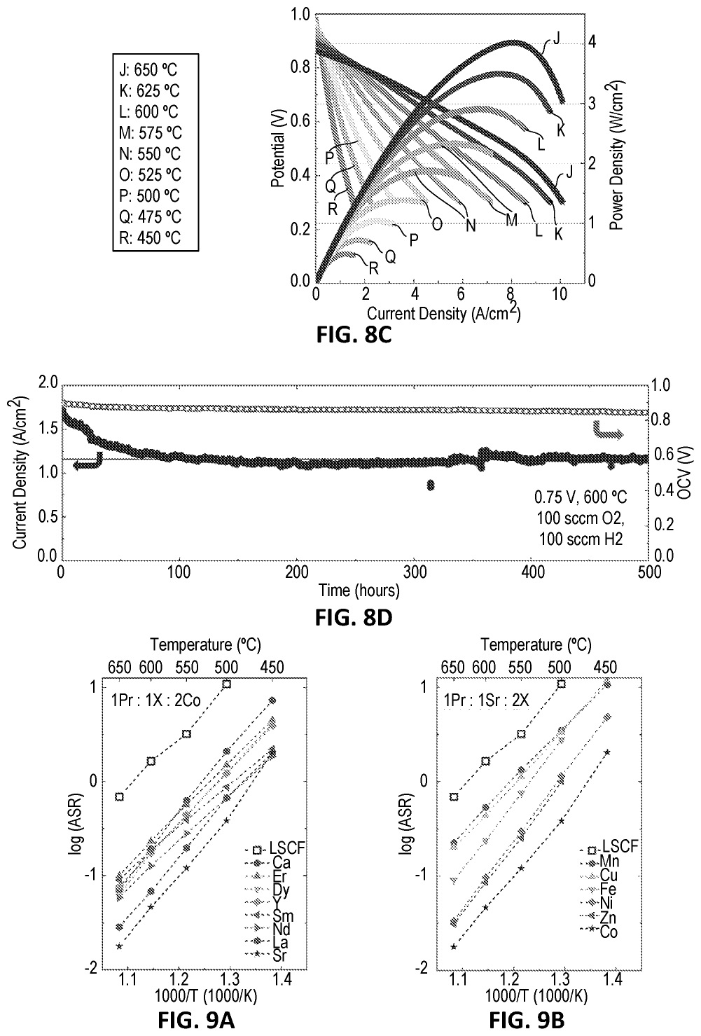

To understand the full potential of the proposed electrode design, full cells were tested with the cathode exposed to pure oxygen (pO₂=1atm) to simulate pressurized operation, the results of which are shown in FIGS. 8A-8D. Coupled with a highly-conductive GDC electrolyte, the extremely active nano-catalysts dispersed on the MIEC scaffold produce an incredibly high performance for the fuel cell. The EIS sweeps of FIG. 8A show that full cell has a total impedance of only 0.031 2 cm² at 650° C. The majority (e.g., 91.3%) of the energy loss can be attributed to ohmic resistance, implying that the oxygen reduction reaction (ORR) overpotential does not limit performance of the cell. Moreover, the non-ohmic impedance contributes significantly less ASR than the ohmic resistance above 500° C., as shown in FIG. 8B. System performance can be further improved by reducing electrolyte thickness. Regardless, the extremely low total ASR allows the cell to exhibit a PPD of 4.01 W/cm² at 650° C., 1.87 W/cm² at 550° C., and 0.48 W/cm² at 450° C., as shown in FIG. 8C. In addition, the potentiostatic (0.75V) aging results of FIG. 8D show a constant open circuit voltage (OCV), as well as stabilization to a constant power output of ˜0.86 W/cm² after 100 hours.

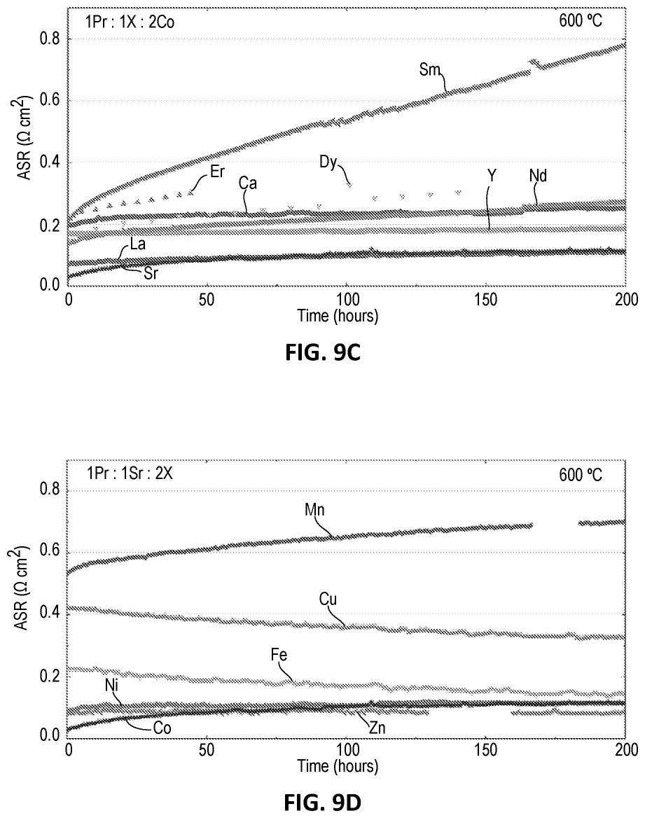

While the above noted examples employ Pr-Sr-Co infiltrate for cathode, the presence of Sr and Co can suffer from stability and supply-chain concerns, respectively. However, other materials can be employed as the electrocatalyst infiltrate to similar effect. For example, Sr was substituted with other large radii 2/3+clements (FIGS. 9A-9B), and Co was substituted with other small transition metals (FIGS. 9C-9D). Compared to the state-of-the-art LSCF-GDC cathode, FIGS. 9A-9B show that all 13 compositions exhibit ˜5× lower ASR, with the majority providing at least 10× improvement across the entire temperature range. Thus, regardless of composition, the nano-structuring produced from this novel, low-temperature cathode preparation approach can achieve such low ASR.

The cathode stability of Sr-substituted infiltrate was evaluated by probing the ASR of symmetrical cells for ˜200 hours at 600° C. As shown in FIG. 9C, the ASR of all compositions increased over time, but the suppressed degradation rate of Pr-La-Co led to an ASR nearly identical to PSC after ˜50 hours of aging. The cathode stability of Co-substituted infiltrate was also evaluated by probing the ASR of symmetrical cells for ˜200 hours at 600° C. As shown in FIG. 9D, Cu, Fe, Ni, and Zn containing infiltrates showed negligible or negative degradation over 200 hours. Further analysis shows this trend continued for more than 1800 hours. Compared to Co, the three alternatives (Fe, Ni, or Zn) provide competitively low ASR, are more abundant, and have less geopolitical concerns.

### Air-Side Porous Functional Layers

Doped ceria electrolytes are the state of the art low-temperature solid oxide electrolytes because of their high ionic conductivity and good material compatibility. Because of the different degrees of Ce4+3+redox states across the electrolyte (as a result of the electrochemical potential gradient), the total electronic conductivity in the electrolyte is directly affected by thickness, gas environments on either side, and temperature. Since cerium reduction is limited to the near anode region, a thicker doped ceria layer can increase the ionic transference number, t_{O}²⁻. However, the increased thickness also contributes to a higher ohmic loss, which inhibits performance at low temperatures. As a result, a typical 20 μm thick GDC electrolyte has only 80% of Vt (theoretical voltage) at 500° C., as the measured OCV relative to Vₜ is directly related to t_{O}²⁻ (t_{O}²⁻=OCV/Vₜ).

To increase t_{O}²⁻ for thin GDC electrolytes (e.g., 20 μm or less) at low temperatures (e.g., ≤650° C.), a porous functional layer (PFL) was provided on the air-side of the electrolyte in order to increase exposure of this ceria layer to higher partial pressure of oxygen (pO₂). In addition, the intrinsic electron charge carrier density in the PFL is significantly lower because of the gas-solid equilibrium of the PFL in air. Moreover, by engineering the PFL with active dopants (e.g., Pr), the oxygen transport in the PFL can be facilitated, leading to synergistic effects that significantly enhance the cell performance. As a result, SOCs incorporating such structures can exhibit much higher OCV, lower area specific resistance (ASR), higher performance and increased durability, for example, achieving more than 2000 hours of cell operation with no performance losses.

Solid oxide fuel cell (SOFC) button cells were made using tape casting. The anode support layer (ASL) was made using a tape casting method. In particular, 60 wt % NiO and 40 wt % GDC were combined, and 3 wt % PMMA was subsequently added to the slurry to reach desired porosity. The anode functional layer (AFL) was also made by tape casting using 48 wt % NiO and 52 wt % GDC. GDC electrolytes having thicknesses of 20 μm, 15 μm, and 10 μm were made by tape casting. The ASL (˜500 μm thick), AFL (˜15 μm thick), and electrolyte (20 μm, 15 μm, or 10 μm thick) were then laminated together using a roll laminator, and subsequently sintered at 1450° C, for 4 hours to form half-cells. SSC-GDC cathode ink was made using SSC, GDC, and ESL 441 ink vehicle (a texanol-based composition sold by ElectroScience). PFL layers were made by the same process as the cathode ink, but with Pr₆O₁₁ powder and GDC. Using a screen-printing method, PFL or SSC-GDC cathode ink was then deposited onto the Ni-GDC/GDC half-cells in a 0.31cm² active area cathode. The cathode and PFL were then cofired at 950° C, for 2 hours.

Electrolyte supported cells were used for the ionic transference number measurement study, where tape cast GDC supports (200-300 μm) were sintered at 1450° C, for 4 hours. Ni-GDC (48% NiO-52% GDC) ink, which was made in a similar manner as the cathode ink, were applied to the cell and sintered at 1200° C, for 2 hours. SSC-GDC/PFL was applied to the opposite side of the electrolyte and sintered at 950° C, for 2 hours. To make symmetrical cells, GDC powders were pressed to make pellets ˜1.5 mm thick. SSC-GDC composite cathode paste and PFL (depending on the configuration) were applied to each side of the symmetrical cell and sintered at 950° C, for 2 hours. For infiltration of SSC-GDC composite cathodes, praseodymium nitrate was first dissolved in deionized water to make a 1M praseodymium nitrate solution, and then the cathode was infiltrated using 6 μL of 1M Praseodymium nitrate solution. The infiltrated cathode was then placed under vacuum for 10 minutes. After the cell was placed under vacuum, it was fired in a furnace at 450° C, for 30 minutes to dry the nitrate precursor.

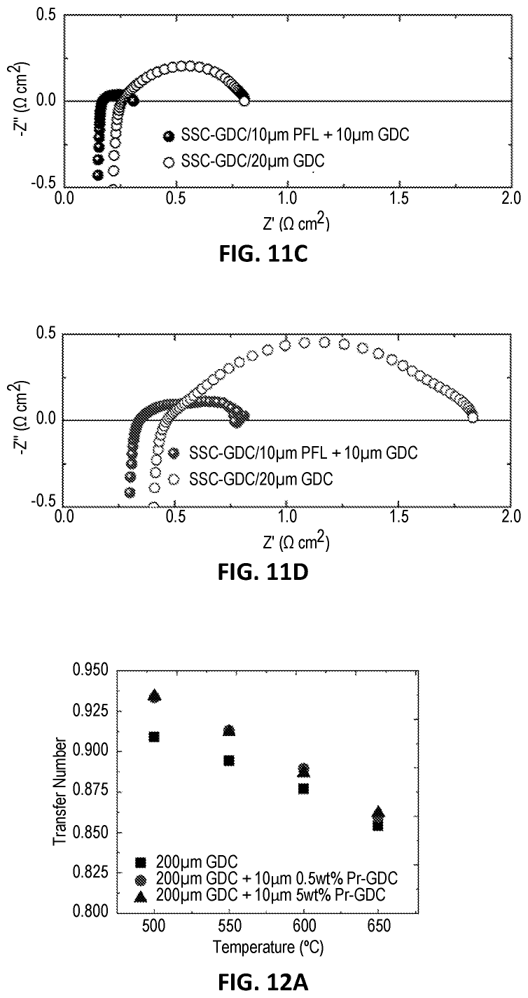

An SOFC was fabricated having the layer configuration of FIG. 2B, with a composite cathode of Sr_{0.5}Sm_{0.5}CoO_{3-δ}-Ce_{0.9}Gd_{0.1}O_{2-δ} (SSC-GDC) and an inserted PFL (e.g., SSC-GDC/PFL/GDC/Ni-GDC). As shown in FIG. 11A, the fabricated structure exhibits discrete layers for the cathode, PFL, dense electrolyte layer (DEL), and anode. The porous microstructure of the PFL is also reflected in the SEM inset of FIG. 2B. Two cells were tested with the same total GDC thickness: one configured with 10 μm DEL +10 μm PFL, and the other configured with a 20 μm DEL. The results of FIG. 11B highlight the impact of the porous engineered microstructure. In particular, the PFL provides two performance enhancements to the cell, (1) an increase in open circuit voltage (OCV) and (2) a decrease in impedance. For example, by providing the PFL layer, the OCV increased from 0.91 to 0.98 V at 500° C. and from 0.88 to 0.95 V at 550° C., an 8% improvement as compared to the DEL only configuration. In addition, by replacing 10 μm of the DEL with PFL, the ohmic ASR drops from 0.25 Ωcm² to 0.17 Ωcm² at 550° C., and from 0.46 Ωcm² to 0.34 Ωcm² at 500° C., as shown by the EIS of FIGS. 11C-11D.

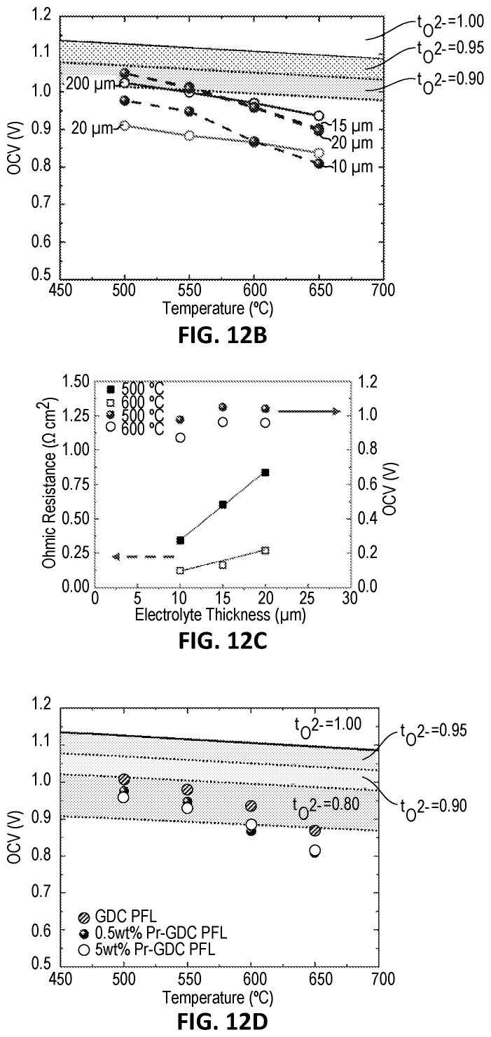

In both of the fabricated examples, the total GDC thickness is the same (e.g., 20 μm). However, when employing a PFL between the DEL and the cathode, half that thickness is porous. This would be expected to increase ohmic ASR due to constriction of ion transport in the porous structure. Yet the provision of the PFL leads to a drop in ASR. Moreover, the non-ohmic polarization with the PFL (0.14 Ωcm² at 550° C. and 0.47 (2cm² at 500° C.) is significantly less than the DEL alone (0.55 Ωcm² at 550° C. and 1.37 Ωcm² at 500° C.). As a result, addition of the PFL leads to a large increase (as much as 257% at 550° C.) in peak power density (PPD)—up to 0.36 W/cm² at 500° C. and 0.76 W/cm² at 550° C. SOFCs with different DEL thicknesses and PFL concentrations (e.g., 0, 0.5, and 5.0 wt % Pr) were tested to understand the OCV enhancement mechanism of the PFL, as shown in FIGS. 12A-12D. The standard PFL concentration referenced throughout the figures is a (0.5 wt % Pr₆O₁₁+GDC) PFL; all other weight percent configurations are denoted (X wt % of Pr+GDC). The effect of the PFL on OCV enhancement was tested by depositing a 10 μm PFL with different Pr concentrations on a 200 μm GDC support. As shown in FIG. 12A, the reduction in OCV at low GDC thickness can be minimized, or at least reduced, by using the PFL. Due to the MIEC in GDC, the apparent ionic transference number, t_{O}²⁻, of 200 μm GDC reaches only 0.91at 500° C. As temperature increases, oxygen non-stoichiometry, x, and electron defects are both thermally activated, leading to the further decrease in t_{O}²⁻ to 0.85 at 650° C. With the PFL, t_{O}²⁻ improves significantly, and this enhancement is more effective at low temperature, even though the PFL is only 5% of the total electrolyte thickness.

FIG. 12B shows the effect of the PFL on OCV for thin anode supported 20 μm GDC electrolytes, with PFL thicknesses ranging from 10 μm to 20 μm. The GDC baselines of 200 μm and 20 μm DEL thicknesses are also shown in FIG. 12B as open symbols with solid lines. The theoretical voltage as well as the levels of t_{O}²⁻ are also shown. When the thickness of GDC decreases from 200 μm to 20 μm, the OCV drops over 10% due to the higher electrochemical gradient (air/H₂@3% H₂O) across the thin electrolyte (5.8 versus 58 mV/μm for 200 to 20 μm thick GDC, respectively), which forces reduction of Ce 4+/3+ redox couple and increases electronic conductivity. Compared to the 20 μm GDC baseline, the presence of PFL increases OCV at all temperatures. With an increase in DEL thickness to 200 μm, the OCV can reach 93% and 90% of theoretical value at 500° C. and 550° C., respectively. But the addition of the 15 um PFL or the 20 μm PFL to a 20 μm thick GDC DEL can increase the OCV thereof to match that of a 200 μm thick GDC DEL. In fact, such PFL-DEL combinations exceeded the 200 μm thick GDC DEL as the temperature drops below 600° C. This external structure design enhances the OCV more effectively than simply increasing GDC thickness, as the OCV of the 20 μm thick DEL +15 μm thick PFL (total thickness of 35 μm) is higher than that of the 200 μm thick GDC with a significantly lower ASR.

Since the extrinsic structure design can minimize the electron conduction in GDC, the thickness of the DEL can be minimized, or at least reduced, to reduce ohmic loss for oxygen transport without sacrificing OCV. FIG. 12C shows the thickness effect of a 10 μm PFL (0.5 wt % PrO₂₋ₓ-GDC) paired with varying DEL thicknesses. The ohmic ASR depended linearly on varying electrolyte thickness, with the lowest value achieved for the 10 μm DEL sample. In addition, the OCV can surpass 1 V with an ohmic ASR of only ˜0.3 Ωcm² at 500° C. The OCV of the 15 μm DEL +10 μm PFL maintained a high OCV (comparable to the OCV of the 20 μm DEL +10 μm PFL configuration), but without the ohmic losses of a 20 μm thick electrolyte. This suggests that over 15 μm the DEL has minimum effect on the OCV increase but contributes to ohmic loss.

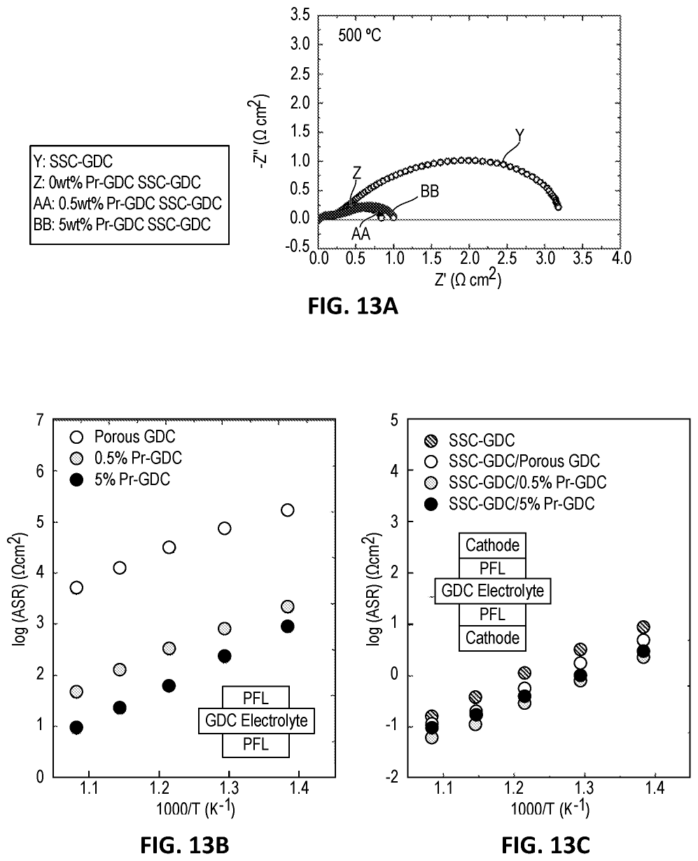

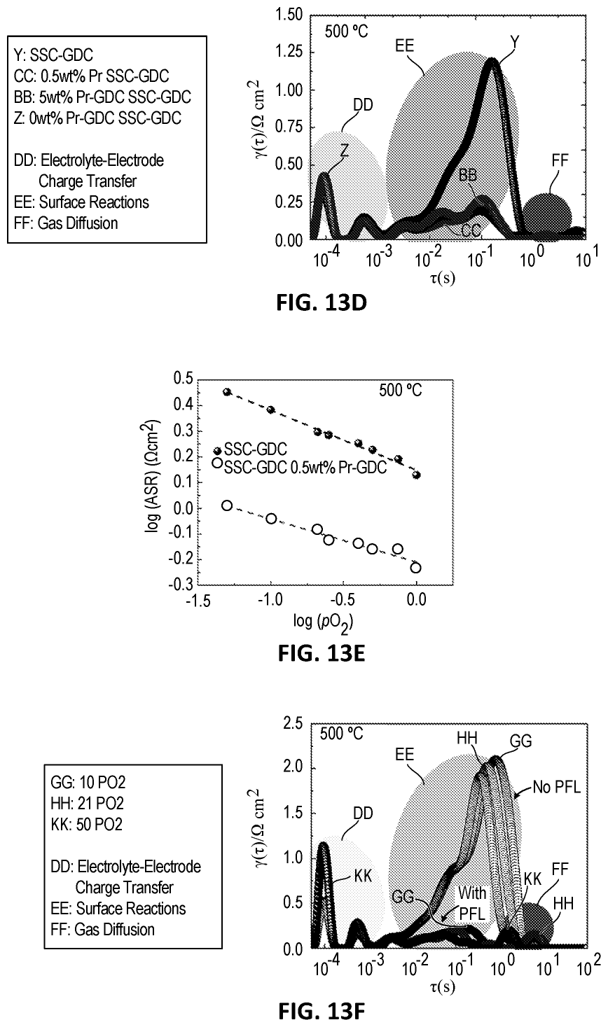

FIG. 12D shows the effect of Pr doping level in the PFL on the OCV enhancement on a 10 μm DEL +10 μm PFL. Adding Pr as a homogenous dopant in the PFL decreases somewhat the OCV enhancement. Without wishing to be bound by any particular theory, it is believed that the external porous structure of the PFL is a primary factor for the decrease in electronic conduction in GDC layers. Nevertheless, the addition of Pr can have a significant benefit on electrochemical performance. The effect of the PFL on the electrochemical performance enhancement was determined using a symmetrical cell configuration. FIG. 13A shows Nyquist plot of SSC-GDC cathode with or without the presence of the PFL. The addition of a PFL reduced polarization impedance, and Pr concentration in the PFL can play a role in the overall cathode performance. A pure porous GDC layer reduced cathode ASR, likely due to the increase in active area at the cathode triple phase boundary, and the addition of multivalent Pr further enhanced the electrochemical performance. For example, the PFL with 0.5 wt % PrO₂₋ₓ had the lowest cathode ASR, 0.7 Ωcm², compared to 3.2 02cm² without a PFL. However, the higher doping level of Pr (5 wt %) may act as a sintering aide, as the microstructure appears to have a densified composition that leads to a decrease in active surface arca.

PFL/GDC symmetrical cells (without SSC-GDC cathode) were further tested to separately determine electrochemical activity of the PFL. The Arrhenius plot of cathode ASR in FIGS. 13B-13C shows that the PFL lacks sufficient cathode activity on its own, regardless of the Pr doping level, as the electrode polarization is 2-3 orders of magnitude higher than the cathode on top of PFL configuration. The impact of Pr is further shown in FIG. 13B, as the PFL acting without cathode had an ASR orders of magnitude higher than conventional SSC-GDC cathodes (as shown in FIG. 13C), confirming that the PFL does not have sufficient cathode activity on its own. There is further evidence that the PFL does not have sufficient electrochemical activity to function as a cathode. In particular, Pr plays a role in increasing cathodic activity in the PFL. Thus, the electrode ASR decreases from on the order of ˜10+Ωcm² at 500° C. in the case of no Pr in the PFL, to on the order of 102 Ωcm² at 500° C, for both cases of Pr in the PFL and without SSC-GDC cathode. This suggests that Pr enhanced electrochemical activity in the PFL.

The distribution of relaxation times (DRT) analysis of FIG. 13D further elucidates how the PFL enhanced cathode performance. The SSC-GDC without a PFL (curve Y) has the highest overall reaction losses in the region (time constant (τ)=10⁻³-10⁰(sec)), which is typically attributed to the surface reaction. With the addition of the PFL, this peak intensity decreased, suggesting that the PFL facilitated surface reaction steps. Based on the further aging results at 500° C. and 600° in Figure S7 of underlying U.S. Provisional Application No. 63/265,921, incorporated herein by reference above, it can be seen that the SSC-GDC with PFL was stable on its own for over 1200 hours at 500° C. and 600° C., maintaining electrode ASRs of ˜0.8 Qcm? and 0.25 Ωcm² respectively. The aging result at 600° C, suggested that the stability of the SSC-GDC+PFL is significantly enhanced compared to the baseline SSC-GDC.

To help illustrate the effect of the PFL on cathode performance, isothermal oxygen partial pressure (pO₂) dependent studies and corresponding DRT analyses were performed, the results of which are shown in FIGS. 13E-13F. Double log plot of cathode ASR versus log (pO₂) in FIG. 13E illustrates that by adding the PFL, the impedance is lowered at all pO₂′s, with a slope change from ¼ to ⅙ indicating a change in the rate-limiting-step on the surface reactions. The DRT results of FIG. 13F deconvolute the impedance results to show that the PFL decreased the reaction losses in the surface reaction region (τ=10⁻³-10⁰(s)).

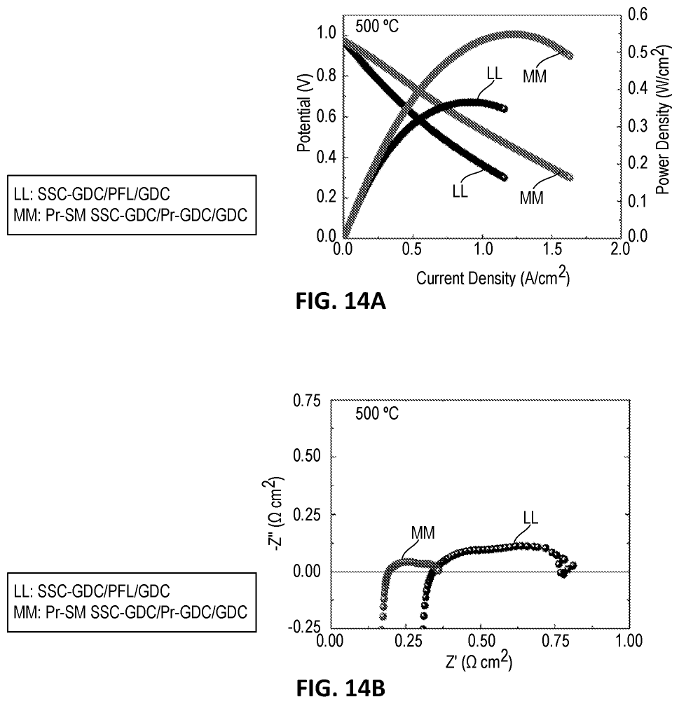

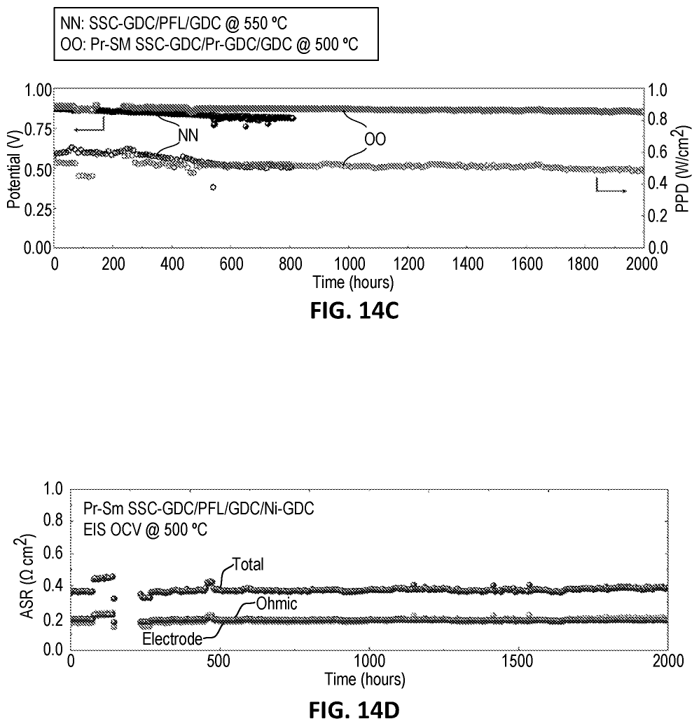

Surface modification (SM) was performed on PFL-based cells to further enhance durability and performance. In particular, the surface modification was performed similar to that described in Huang et al., “Nanointegrated, High-Performing Cobalt-Free Bismuth-Based Composite Cathode for Low-Temperature Solid Oxide Fuel Cells.” ACS Appl. Mater. Interfaces, 2018, 10(34): pp. 28635-43, which is incorporated herein by reference. The results are shown in FIGS. 14A-14D. As shown in FIG. 14A, PFL-based SSC-GDC SOFC had a PPD of 0.35 W/cm² at 500° C. in H₂. With the Pr surface modification cathode (Pr-SM SSC-GDC), a PPD of 0.55 W/cm² was reached. The iV result can be directly correlated to the cell impedance, where the Pr-SM SSC-GDC/PFL cell had a total ASR of 0.3 22cm² at 500° C. whereas the SSC-GDC/PFL had a total ASR of 0.75 Ωcm² at 500° C., as shown in FIG. 14B. The cathode surface modification thus significantly lowered the cell ASR.

Cells were aged at 500° C. and 550° C. under 0.2 A/cm² with humidified H₂ fuel, and the terminal voltage and the corresponding cell ASR are shown in FIGS. 14C-14D, respectively. As shown in FIG. 14C, the SSC-GDC/PFL cell (NN curve) exhibited a high durability at 550° C, for over 800 hours and demonstrates that the porous design of the PFL can maintain its functionality even after long-term aging. But the Pr-SM cell (OO curve) further enhanced the performance and allowed the cell to possess the same power density while operating at 50° C, lower. The Pr-SM cell showed a PPD of 0.5 W/cm² at 500° C. with excellent stability for over 2000 hours of operation. The cell ASR of the Pr-SM SSC-GDC/GDC/Ni-GDC is shown in FIG. 14D, resolving the ohmic and non ohmic contributions. No major degradation appeared over the course of 2000 hours of operation.

### ADDITIONAL EXAMPLES OF THE DISCLOSED TECHNOLOGY

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A solid oxide cell comprising:
a nonporous oxide layer constructed to conduct oxygen ions and to operate as a solid electrolyte;
one or more first porous layers disposed over a first side of the nonporous oxide layer; and
one or more second porous layers disposed over a second side of the nonporous oxide layer opposite the first side,
wherein the nonporous oxide layer has a density greater than that of each of the first and second porous layers,
an electronic conductivity of the nonporous oxide layer is less than 25% of an ionic conductivity of the nonporous oxide layer,
for each of the first and second porous layers, an electronic conductivity of the respective porous layer is greater than 25% of an ionic conductivity of the respective porous layer, at least one of the one or more first porous layers is constructed to operate as a first electrode, and
at least one of the one or more second porous layers is constructed to operate as a second electrode.

Clause 2. A solid oxide cell comprising:
a nonporous oxide layer constructed to conduct oxygen ions and to operate as a solid electrolyte;
a porous functional layer disposed over a first side of the nonporous oxide layer;
one or more first porous layers disposed over a side of the porous functional layer opposite the nonporous oxide layer; and
one or more second porous layers disposed over a second side of the nonporous oxide layer the opposite the first side,
wherein the nonporous oxide layer has a density greater than that of the porous functional layer,
an electronic conductivity of the nonporous oxide layer is less than 25% of an ionic conductivity of the nonporous oxide layer,
the porous functional layer is effective to increase an ionic transference number of the nonporous oxide layer and the porous functional layer to at least 0.9 at a temperature less than or equal to 550° C.,
at least one of the one or more first porous layers is constructed to operate as a first electrode, and
at least one of the one or more second porous layers is constructed to operate as a second electrode.

Clause 3. The solid oxide cell of any clause or example herein, in particular, any one of Clauses 1-2, wherein the one or more second porous layers comprise a nickel-cermet of ceria, a nickel-cermet of zirconia, or a mixed ionic electronic conducting oxide.

Clause 4. The solid oxide cell of any clause or example herein, in particular, any one of Clauses 1-3, wherein the one or more second porous layers are formed of a nickel-cermet of ceria, a nickel-cermet of zirconia, nickel-cermet of gallate, a molybdate, a nickel-cermet of molybdate, a chromate, a nickel-cermet of chromate, a vanadate, or a nickel-cermet of vanadate.

Clause 5. The solid oxide cell of any clause or example herein, in particular, any one of Clauses 1-4, wherein the one or more first porous layers comprise ceria or bismuth oxide.

Clause 6. The solid oxide cell of any clause or example herein, in particular, any one of Clauses 1-5, wherein the one or more first porous layers comprise doped ceria, a cubic bismuth oxide, a rhombohedral bismuth oxide, or a doped rhombohedral bismuth oxide.

Clause 7. The solid oxide cell of any clause or example herein, in particular, any one of Clauses 1-6, wherein the one or more first porous layers comprise a doped ceria with one or more lanthanides added.

Clause 8. The solid oxide cell of any clause or example herein, in particular, Clause 7, wherein the added one or more lanthanides are praseodymium, samarium, or both praseodymium and samarium.

Clause 9. The solid oxide cell of any clause or example herein, in particular, any one of Clauses 1-8, wherein the one or more first porous layers are infiltrated with one or more electrocatalytic oxides.

Clause 10. The solid oxide cell of any clause or example herein, in particular, Clause 9, wherein the one or more electrocatalytic oxides comprises multiphase electrocatalysts formed by at least A and B, and a molar ratio of A:B in the one or more multiphase electrocatalysts is about 1:1.

Clause 11. The solid oxide cell of any clause or example herein, in particular, Clause 10, wherein A is a Group 2 element, a Group 3 element, or a lanthanide, and B is a Period 4 element.

Clause 12. The solid oxide cell of any clause or example herein, in particular, any one of Clauses 10-11, wherein:
A is selected from a group consisting of praseodymium (Pr), calcium (Ca), strontium (Sr), yttrium (Y), lanthanum (La), neodymium (Nd), samarium (Sm), dysprosium (Dy), and erbium (Er); and/or
B is selected from a group consisting of manganese (Mn), iron (Fe), cobalt (Co), nickel (Ni), copper (Cu), and zinc (Zn).

Clause 13. The solid oxide cell of any clause or example herein, in particular, any one of Clauses 1-4, wherein the one or more first porous layers comprises ceria, bismuth oxide, or a composite material formed of (i) ceria or bismuth oxide with (ii) one or more electronically-conducting and electrocatalytic oxides.

Clause 14. The solid oxide cell of any clause or example herein, in particular, any one of Clauses 1-4, wherein the one or more first porous layers comprise a material selected from the group consisting of lanthanum strontium cobalt oxide (LSC), lanthanum strontium cobalt ferrite (LSCF), yttria stabilized zirconia (YSZ), scandia stabilized zirconia (SSZ), gadolinia doped ceria (GDC), samaria doped ceria (SDC), samaria-neodymium doped ceria (SNDC), erbia stabilized bismuth oxide (ESB), dysprosium tungsten stabilized bismuth oxide (DWSB), yttria stabilized bismuth oxide (YSB), a rhombohedral bismuth oxide, strontium and magnesium doped lanthanum gallate (LSGM), strontium samarium cobalt oxide (SSC), and Ln2NiO_{4+δ} nickelate where Ln is a lanthanide.

Clause 15. The solid oxide cell of any clause or example herein, in particular, Clause 1, further comprising a porous functional layer disposed between and in direct contact with one of the first porous layers and the nonporous oxide layer.

Clause 16. The solid oxide cell of any clause or example herein, in particular, any one of Clauses 2-15, wherein the porous functional layer consists essentially of ceria or bismuth oxide.

Clause 17. The solid oxide cell of any clause or example herein, in particular, any one of Clauses 2-16, wherein the porous functional layer is constructed to increase an open circuit voltage of the solid oxide cell.

Clause 18. The solid oxide cell of any clause or example herein, in particular, Clause 17, wherein the open circuit voltage is at least 0.9 V at a temperature in a range of 500-550° C., inclusive.

Clause 19. The solid oxide cell of any clause or example herein, in particular, any one of Clauses 2-18, wherein:
a thickness of the porous functional layer along a first direction from the first electrode to the second electrode is less than or equal to about 20 μm; and/or
a thickness of the nonporous oxide layer along the first direction is less than or equal to about 20 μm.

Clause 20. The solid oxide cell of any clause or example herein, in particular, any one of Clauses 1-19, wherein:
at least one of the one or more second porous layers is configured to operate as an anode and at least one of the one or more first porous layers is configured to act as a cathode when electrochemical oxidation occurs at the second side; and/or
at least one of the one or more second porous layers is configured to act as a cathode and at least one of the one or more first porous layers is configured to act as an anode when reduction occurs at the second side.

Clause 21. The solid oxide cell of any clause or example herein, in particular, any one of Clauses 1-20, wherein:
the one or more first porous layers are configured to receive an input stream containing oxygen concentration in a range of 20-100% (mole fraction), inclusive;
the one or more second porous layers are configured to receive a fuel; and the solid oxide cell is configured to operate as a solid oxide fuel cell (SOFC) by electrochemically oxidizing the fuel to generate electricity.

Clause 22. The solid oxide cell of any clause or example herein, in particular, any one of Clauses 1-20, wherein:
the one or more second porous layers are configured to receive an input stream containing H₂O and/or CO₂; and
the solid oxide cell is configured to operate as a solid oxide electrolysis cell (SOEC) by electrochemically reducing the H₂O or CO₂ on the second side and to evolve O₂ on the first side.

Clause 23. The solid oxide cell of any clause or example herein, in particular, any one of Clauses 1-22, wherein:
the solid oxide cell is configured to reverse polarization to switch between operation as a solid oxide fuel cell (SOFC) and operation as a solid oxide electrolysis cell (SOEC);
the solid oxide cell is configured to, during a first mode of operation, electrolyze H₂O and/or CO₂ provided to one of the first and second electrodes so as to produce a fuel; and
the solid oxide cell is configured to, during a second mode of operation, oxidize the fuel to generate electricity.

Clause 24. The solid oxide cell of any clause or example herein, in particular, any one of Clauses 1-23, wherein the nonporous oxide layer comprises ceria, zirconia, bismuth oxide, or lanthanum gallate.

Clause 25. A method of fabricating a solid oxide cell, the method comprising:
(a) providing one or more first precursors for forming one or more second porous layers;
(b) providing one or more second precursors for forming a nonporous oxide layer on the one or more first precursors;
(c) sintering the first and second precursors at a temperature greater than or equal to a first threshold, so as to form the one or more second porous layers over a second side of the nonporous oxide layer;
(d) providing one or more third precursors for forming one or more first porous layers over a first side of the nonporous oxide layer opposite the second side; and
(e) sintering the one or more third precursors at a temperature less than the first threshold, so as to form the one or more first porous layers over the first side of the nonporous oxide layer,
wherein the nonporous oxide layer has a density greater than that of the first and second porous layers,
for each of the first and second porous layers, an electronic conductivity of the respective porous layer is greater than 25% of an ionic conductivity of the respective porous layer,
at least one of the one or more first porous layers is constructed to operate as a first electrode, and
at least one of the one or more second porous layers is constructed to operate as a second electrode.

Clause 26. A method of fabricating a solid oxide cell, the method comprising:
(a) providing one or more first precursors for forming one or more second porous layers;
(b) providing one or more second precursors for forming a nonporous oxide layer on the one or more first precursors;
(c) sintering the first and second precursors at a temperature greater than or equal to a first threshold, so as to form the one or more second porous layers over a second side of the nonporous oxide layer;
(d) providing one or more third precursors for forming a porous functional layer over a first side of the nonporous oxide layer opposite the second side;
(e) providing one or more fourth precursors for forming one or more first porous layers over the one or more third precursors; and
(f) sintering the third and fourth precursors at a temperature less than the first threshold, so as to form the porous functional layer over the first side of the nonporous oxide layer and to form the one or more first porous layer over a side of the porous functional layer opposite the nonporous oxide layer,
wherein the nonporous oxide layer has a density greater than that of the first and second porous layers,
for each of the first and second porous layers, an electronic conductivity of the respective porous layer is greater than 25% of an ionic conductivity of the respective porous layer,
the porous functional layer is effective to increase an ionic transference number of the nonporous oxide layer and the porous functional layer to at least 0.9 at a temperature less than or equal to 550° C.,
at least one of the one or more first porous layers is constructed to operate as a first electrode, and
at least one of the one or more second porous layers is constructed to operate as a second electrode.

Clause 27. The method of any clause or example herein, in particular, any one of Clauses 25-26, wherein the first threshold is about 1000° C.

Clause 28. The method of any clause or example herein, in particular, any one of Clauses 25-27, wherein:
the sintering of the one or more third precursors or the sintering of the third and fourth precursors is performed at a temperature of about 950° C.;
the sintering of the first and second precursors is performed at a temperature of about 1450° C.; or
both of the above.

Clause 29. The method of any clause or example herein, in particular, any one of Clauses 25-28, wherein the one or more second porous layers comprise a nickel-cermet of ceria, a nickel-cermet of zirconia, or a mixed ionic electronic conducting oxide.

Clause 30. The method of any clause or example herein, in particular, any one of Clauses 25-29, wherein the one or more second porous layers are formed of a nickel-cermet of ceria, nickel-cermet of zirconia, a nickel-cermet of gallate, a molybdate, a nickel-cermet of molybdate, a chromate, a nickel-cermet of chromate, a vanadate, or a nickel-cermet of vanadate.

Clause 31. The method of any clause or example herein, in particular, any one of Clauses 25-30, wherein the one or more first porous layers comprise ceria or bismuth oxide.

Clause 32. The method of any clause or example herein, in particular, any one of Clauses 25-31, wherein the one or more first porous layers comprise doped ceria, a cubic bismuth oxide, a rhombohedral bismuth oxide, or a doped rhombohedral bismuth oxide.

Clause 33. The method of any clause or example herein, in particular, any one of Clauses 25-32, wherein the one or more first porous layers comprise a doped ceria with one or more lanthanides added.

Clause 34. The method of any clause or example herein, in particular, Clause 33, wherein the added one or more lanthanides are praseodymium, samarium, or both praseodymium and samarium.

Clause 35. The method of any clause or example herein, in particular, any one of Clauses 25-34, further comprising, after forming the one or more first porous layers, infiltrating at least one of the one or more first porous layers with one or more electrocatalytic oxides.

Clause 36. The method of any clause or example herein, in particular, Clause 35, wherein the infiltrating comprises:
(f1) providing a dose of one or more electrocatalysts in solution to the at least one of the one or more first porous layers;
(f2) exposing the at least one of the one or more first porous layers with the dose to vacuum;
(f3) repeating (f1) and (f2) with another dose of one or more electrocatalyst in solution; and
(f4) after (f3), subjecting the one or more first porous layers to a temperature of about 450° C, so as to evaporate or combust the solution.

Clause 37. The method of any clause or example herein, in particular, any one of Clauses 35-36, wherein the one or more electrocatalytic oxides comprises multiphase electrocatalysts formed by at least A and B, and a molar ratio of A:B in the one or more multiphase electrocatalysts is about 1:1.

Clause 38. The method of any clause or example herein, in particular, Clause 37, wherein A is a Group 2 element, a Group 3 element, or a lanthanide, and B is a Period 4 element.

Clause 39. The method of any clause or example herein, in particular, any one of Clauses 37-38, wherein:
A is selected from a group consisting of praseodymium (Pr), calcium (Ca), strontium (Sr), yttrium (Y), lanthanum (La), neodymium (Nd), samarium (Sm), dysprosium (Dy), and erbium (Er); and/or
B is selected from a group consisting of manganese (Mn), iron (Fe), cobalt (Co), nickel (Ni), copper (Cu), and zinc (Zn).

Clause 40. The method of any clause or example herein, in particular, any one of Clauses 25-39, wherein the providing one or more third precursors of (d) comprises:
(d1) mixing ceria with or without one or more lanthanide oxides into an ink; and
(d2) mixing a pore former into the ink.

Clause 41. The method of any clause or example herein, in particular, Clause 40, wherein the pore former comprises poly(methyl methacrylate).

Clause 42. The method of any clause or example herein, in particular, any one of Clauses 25-30, wherein the one or more first porous layers comprises ceria, bismuth oxide, or a composite material formed of (i) ceria or bismuth oxide with (ii) one or more electronically-conducting and electrocatalytic oxides.

Clause 43. The method of any clause or example herein, in particular, any one of Clauses 25-30, wherein the one or more first porous layers comprise a material selected from the group consisting of lanthanum strontium cobalt oxide (LSC), lanthanum strontium cobalt ferrite (LSCF), yttria stabilized zirconia (YSZ), scandia stabilized zirconia (SSZ), gadolinia doped ceria (GDC), samaria doped ceria (SDC), samaria-neodymium doped ceria (SNDC), erbia stabilized bismuth oxide (ESB), dysprosium tungsten stabilized bismuth oxide (DWSB), yttria stabilized bismuth oxide (YSB), a rhombohedral bismuth oxide, strontium and magnesium doped lanthanum gallate (LSGM), strontium samarium cobalt oxide (SSC), and Ln2NiO_{4+δ} nickelate where Ln is a lanthanide.

Clause 44. The method of any clause or example herein, in particular, Clause 25, further comprising:
prior to (d), providing one or more fourth precursors for forming a porous functional layer on the first side of the nonporous oxide layer,
wherein the providing of (d) comprises providing the one or more third precursors on the one or more fourth precursors, and
the sintering of (e) forms the one or more fourth precursors as the porous functional layer disposed between and in direct contact with one of the first porous layers and the nonporous oxide layer.

Clause 45. The method of any clause or example herein, in particular, any one of Clauses 26-44, wherein the porous functional layer consists essentially of ceria or bismuth oxide.

Clause 46. The method of any clause or example herein, in particular, any one of Clauses 26-45, wherein the porous functional layer is constructed to increase an open circuit voltage of the solid oxide cell.

Clause 47. The method of any clause or example herein, in particular, any one of Clauses 26-46, wherein:
a thickness of the porous functional layer along a first direction from the first electrode to the second electrode is less than or equal to about 20 μm; and/or
a thickness of the nonporous oxide layer along the first direction is less than or equal to about 20 μm.

Clause 48. The method of any clause or example herein, in particular, any one of Clauses 25-47, wherein the nonporous oxide layer comprises ceria, zirconia, bismuth oxide, or lanthanum gallate.

Clause 49. The method of any clause or example herein, in particular, any one of Clauses 25-48, wherein the providing of (a), the providing of (b), the providing of (d), and/or the providing of (e) comprises tape casting, blade coating, laminating, screen printing, or any combination of the foregoing.

Clause 50. The method of any clause or example herein, in particular, any one of Clauses 25-49, wherein (a) comprises:
(a1) mixing about 60 wt % nickel oxide (NiO) and about 40 wt % gadolinium-doped ceria (GDC) into a first slurry;
(a2) mixing a pore former into the first slurry, the first slurry with pore former corresponding to a porous support layer of the second electrode; and
(a3) mixing about 48 wt % NiO and about 52 wt % GDC into a second slurry, the second slurry corresponding to a porous functional layer of the second electrode.

Clause 51. The method of any clause or example herein, in particular, Clause 50, wherein the pore former comprises poly(methyl methacrylate).

Clause 52. A solid oxide cell formed by the method of any clause or example herein, in particular, any one of Clauses 25-51.

### CONCLUSION

Any of the features illustrated or described herein, for example, with respect to FIGS. 1A-14D and Clauses 1-52, can be combined with any other feature illustrated or described herein, for example, with respect to 1A-14D and Clauses 1-52 to provide materials, systems, devices, structures, methods, and/or embodiments not otherwise illustrated or specifically described herein. All features described herein are independent of one another and, except where structurally impossible, can be used in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. A solid oxide cell comprising:
a nonporous oxide layer constructed to conduct oxygen ions and to operate as a solid electrolyte;
one or more first porous layers disposed over a first side of the nonporous oxide layer; and
one or more second porous layers disposed over a second side of the nonporous oxide layer opposite the first side,
wherein the nonporous oxide layer has a density greater than that of each of the first and second porous layers,
an electronic conductivity of the nonporous oxide layer is less than 25% of an ionic conductivity of the nonporous oxide layer,
for each of the first and second porous layers, an electronic conductivity of the respective porous layer is greater than 25% of an ionic conductivity of the respective porous layer,
at least one of the one or more first porous layers is constructed to operate as a first electrode, and
at least one of the one or more second porous layers is constructed to operate as a second electrode.

2. A solid oxide cell comprising:
a nonporous oxide layer constructed to conduct oxygen ions and to operate as a solid electrolyte;
a porous functional layer disposed over a first side of the nonporous oxide layer;
one or more first porous layers disposed over a side of the porous functional layer opposite the nonporous oxide layer; and
one or more second porous layers disposed over a second side of the nonporous oxide layer the opposite the first side,
wherein the nonporous oxide layer has a density greater than that of the porous functional layer,
an electronic conductivity of the nonporous oxide layer is less than 25% of an ionic conductivity of the nonporous oxide layer,
the porous functional layer is effective to increase an ionic transference number of the nonporous oxide layer and the porous functional layer to at least 0.9 at a temperature less than or equal to 550° C.,
at least one of the one or more first porous layers is constructed to operate as a first electrode, and
at least one of the one or more second porous layers is constructed to operate as a second electrode.

3. The solid oxide cell of claim 1, wherein the one or more second porous layers comprise a nickel-cermet of ceria, a nickel-cermet of zirconia, or a mixed ionic electronic conducting oxide.

4-8. (canceled)

9. The solid oxide cell of claim 1, wherein the one or more first porous layers comprise ceria or bismuth oxide, and the one or more first porous layers are infiltrated with one or more electrocatalytic oxides.

10. The solid oxide cell of claim 9, wherein the one or more electrocatalytic oxides comprises multiphase electrocatalysts formed by at least A and B, and a molar ratio of A:B in the one or more multiphase electrocatalysts is about 1:1, A is a Group 2 element, a Group 3 element, or a lanthanide, and B is a Period 4 element.

11-12. (canceled)

13. The solid oxide cell of claim 1, wherein the one or more first porous layers comprises ceria, bismuth oxide, or a composite material formed of (i) ceria or bismuth oxide with (ii) one or more electronically-conducting and electrocatalytic oxides.

14. The solid oxide cell of claim 1, wherein the one or more first porous layers comprise a material selected from the group consisting of lanthanum strontium cobalt oxide (LSC), lanthanum strontium cobalt ferrite (LSCF), yttria stabilized zirconia (YSZ), scandia stabilized zirconia (SSZ), gadolinia doped ceria (GDC), samaria doped ceria (SDC), samaria-neodymium doped ceria (SNDC), erbia stabilized bismuth oxide (ESB), dysprosium tungsten stabilized bismuth oxide (DWSB), yttria stabilized bismuth oxide (YSB), a rhombohedral bismuth oxide, strontium and magnesium doped lanthanum gallate (LSGM), strontium samarium cobalt oxide (SSC), and Ln₂NiO_{4+δ} nickelate where Ln is a lanthanide.

15. The solid oxide cell of claim 1, further comprising:
a porous functional layer disposed between and in direct contact with one of the first porous layers and the nonporous oxide layer,
wherein the porous functional layer consists essentially of ceria or bismuth oxide, and
the porous functional layer is constructed to increase an open circuit voltage of the solid oxide cell.

16-19. (canceled)

20. The solid oxide cell of claim 1, wherein:
at least one of the one or more second porous layers is configured to operate as an anode and at least one of the one or more first porous layers is configured to act as a cathode when electrochemical oxidation occurs at the second side; and/or
at least one of the one or more second porous layers is configured to act as a cathode and at least one of the one or more first porous layers is configured to act as an anode when reduction occurs at the second side.

21. The solid oxide cell of claim 1, wherein:
the one or more first porous layers are configured to receive an input stream containing oxygen concentration in a range of 20-100% (mole fraction), inclusive;
the one or more second porous layers are configured to receive a fuel; and
the solid oxide cell is configured to operate as a solid oxide fuel cell (SOFC) by electrochemically oxidizing the fuel to generate electricity.

22. The solid oxide cell of claim 1, wherein:
the one or more second porous layers are configured to receive an input stream containing H₂O and/or CO₂; and
the solid oxide cell is configured to operate as a solid oxide electrolysis cell (SOEC) by electrochemically reducing the H₂O or CO₂ on the second side and to evolve O₂ on the first side.

23. The solid oxide cell of claim 1, wherein:
the solid oxide cell is configured to reverse polarization to switch between operation as a solid oxide fuel cell (SOFC) and operation as a solid oxide electrolysis cell (SOEC);
the solid oxide cell is configured to, during a first mode of operation, electrolyze H₂O and/or CO₂ provided to one of the first and second electrodes so as to produce a fuel; and
the solid oxide cell is configured to, during a second mode of operation, oxidize the fuel to generate electricity.

24. The solid oxide cell of claim 1, wherein the nonporous oxide layer comprises ceria, zirconia, bismuth oxide, or lanthanum gallate.

25. A method of fabricating a solid oxide cell, the method comprising:
(a) providing one or more first precursors for forming one or more second porous layers;
(b) providing one or more second precursors for forming a nonporous oxide layer on the one or more first precursors;
(c) sintering the first and second precursors at a temperature greater than or equal to a first threshold, so as to form the one or more second porous layers over a second side of the nonporous oxide layer;
(d) providing one or more third precursors for forming one or more first porous layers over a first side of the nonporous oxide layer opposite the second side; and
(e) sintering the one or more third precursors at a temperature less than the first threshold, so as to form the one or more first porous layers over the first side of the nonporous oxide layer,
wherein the nonporous oxide layer has a density greater than that of the first and second porous layers,
for each of the first and second porous layers, an electronic conductivity of the respective porous layer is greater than 25% of an ionic conductivity of the respective porous layer,
at least one of the one or more first porous layers is constructed to operate as a first electrode, and
at least one of the one or more second porous layers is constructed to operate as a second electrode.

26-30. (canceled)

31. The method of claim 25, wherein the one or more first porous layers comprise ceria or bismuth oxide.

32-34. (canceled)

35. The method of claim 31, further comprising, after forming the one or more first porous layers, infiltrating at least one of the one or more first porous layers with one or more electrocatalytic oxides.

36. The method of claim 35, wherein the infiltrating comprises:
(f1) providing a dose of one or more electrocatalysts in solution to the at least one of the one or more first porous layers;
(f2) exposing the at least one of the one or more first porous layers with the dose to vacuum;
(f3) repeating (f1) and (f2) with another dose of one or more electrocatalyst in solution; and
(f4) after (f3), subjecting the one or more first porous layers to a temperature of about 450° C, so as to evaporate or combust the solution.

37-39. (canceled)

40. The method of claim 31, wherein the providing one or more third precursors of (d) comprises:
(d1) mixing ceria with or without one or more lanthanide oxides into an ink; and
(d2) mixing a pore former into the ink.

41. The method of claim 40, wherein the pore former comprises poly(methyl methacrylate).

42-49. (canceled)

50. The method of claim 25, wherein (a) comprises:
(a1) mixing about 60 wt % nickel oxide (NiO) and about 40 wt % gadolinium-doped ceria (GDC) into a first slurry;
(a2) mixing a pore former into the first slurry, the first slurry with pore former corresponding to a porous support layer of the second electrode; and
(a3) mixing about 48 wt % NiO and about 52 wt % GDC into a second slurry, the second slurry corresponding to a porous functional layer of the second electrode.

51. (canceled)
